(19) United States
(12) Patent Application Publication
(10) Pub. No.: US 2021/0081923 A1
(43) Pub. Date: Mar. 18, 2021

(54) AUTHENTICATION AND AUTHORISATION

(71) Applicant: SEMAFONE LIMITED, Guildford, Surrey (GB)

(72) Inventors: Ben RAFFERTY, Guildford (GB); Dirk NIGGEMANN, Guildford (GB)

(73) Assignee: SEMAFONE LIMITED, Guildford, Surrey (GB)

(21) Appl. No.: 16/954,051

(22) PCT Filed: Dec. 14, 2018
(86) PCT No.: PCT/GB2018/053639

§ 371 Date: Jun. 15, 2020

(30) Foreign Application Priority Data
Dec. 15, 2017 (GB) 1721028.7

(51) Int. Cl. G06Q 20/32; H04L 29/06

(52) U.S. Cl. CPC G06Q 20/3223; H04L 63/102; H04L 63/08

(57) ABSTRACT

A method (preferably, performed by an authentication server) of authenticating a request made by a first party of a second party, comprising: receiving from the first party a request and a first symbol string obtained by the first party from the second party, the first symbol string being determined from the request; generating a second symbol string in dependence on the request; authenticating the request of the first party in dependence on the first and second symbol strings.

This invention relates to a method of and apparatus for authentication and authorisation, and in particular to the use of authentication and authorisation word strings, such as may be spoken for example during a telephone call or other verbal communication. The invention also relates to a system providing reasonable to strong authentication for use in the transmission of sensitive information, as may be used in financial systems, especially for the processing of payments, or when dealing with or authorising the use of personally identifiable information for processing or authentication.

In many situations it is necessary to provide some form of authentication and/or authorisation. For example, a service provider may require a prospective user of the service to confirm their identity to ensure that the user requesting the service is not attempting to use the service fraudulently by assuming the identity another user.

Authentication generally requires a user to provide some identifying evidence based on at least one of three factors or identifiers: something known (such as a password, passcode or passphrase—the terms are often used interchangeably), something owned (such as a smartcard or smartphone) or something inherent (such a biometric property, for example a fingerprint).

Traditionally, for many applications use of a single authentication factor has been considered sufficient (eg. a password to access a computer system); however, with increasing security concerns has become increasingly common to use two factor authentication (2FA), where a user requires two types of factor or identifier (for example, possession of a specific user smartphone and knowledge of a passcode) in order to be authenticated. Generally, the term multi-factor authentication (MFA) is used when more than one factor is required for authentication.

Secure authentication is especially important for financial transactions, where it is required to confirm that the means of payment being used belong to the person making the payment. Secure authentication may also be required when dealing with sensitive or personally identifiable information. This has led to a number of developments, including:
Chip-and-PIN, as used for so-called card-present payments, wherein a user authorises payment by presenting a payment card (something owned) and inputting via a keypad a personal identification number or PIN (something known).
Single-use or “one time” passcodes (OTP), as may be used for authorising a one-off payment. The user is issued with a fob (something owned), which is used in combination with a PIN (something known), entered via the fob keypad, to generate the OTP, which in some embodiments are set to expire after a predetermined time, ie. time-based OTP (TOTP), to be transmitted to the bank. OTP are also used for accessing on-line banking websites.
Out-of-band authentication (OOBA), as for some smartphone payment applications, wherein the authentication process is conducted over a connection or channel separate from the main communication channel, such that the application generally communicates via the phone data network connection except for part of the authentication process which involves an OTP sent via a simple messaging service (SMS) to the smartphone be entered via its keypad into the application before the payment is enacted.

Financial regulations such as such as PSD2 may require the use of MFA and/or OOBA. Specifically, PSD2 requires payments to use Strong Customer Authentication (SCA) with authentication based on the use of two or more identifying elements which are independent. This ensures that a breach in the security of one element does not compromise the other(s). Furthermore, the SCA architecture as a whole is designed in such a way as to protect the confidentiality of the authentication data.

Another area in which authentication is required is during voice communication, for example during a telephone call such as when a caller is in communication with an agent at a contact centre. The process of authentication is complicated by the limitations inherent with using a voice channel for communication, coupled with the use of a potentially untrustworthy human intermediary.

Schemes such as that previously developed by the applicant (described in international PCT patent application WO2009136163) allow the caller to input sensitive payment card details during the call via the telephone keypad, the resulting DTMF tones being transmitted in the voice channel, the sensitive information being extracted from the tones by a call processor which relays the payment information to an authorisation or other external entity while blocking at least some DTMF tones from the agent and thereby preventing the sensitive information being disclosed to the agent.

Common to all the above schemes is the requirement for the user to input a passcode or other sensitive information via a keypad. This is not always practical.

There is therefore a need for an authentication/authorisation scheme which may be used in the voice channel and which does not require use of a keypad, preferably one which can use voice alone.

This is to be distinguished from purely biometric or ‘voice-print’ authentication schemes which are based on identifying characteristics of the user's voice. Such systems are especially sensitive to the quality of the voice channel, being prone to false-positive or false-negative authentication errors. They are also vulnerable to the nefarious use of voice imitating equipment.

Such an authentication scheme would ideally be sufficiently secure. Password strength in often described terms of information entropy, measured in bits. For a random password of length L bits, chosen from N possible symbols, the password entropy H is given by the base 2 logarithm of the number of possible combinations N^{L}, ie.

$$H = {log}_{2} {N}^{L} = L \frac{log N}{log 2}$$

At present, password strengths are rated approximately as follows:

| | |
|---|---|
| Password entropy | Password strength |

| | | |
|---|---|---|
| <28 | bits | Very Weak |
| 28-35 | bits | Weak |
| 36-59 | bits | Reasonable |
| 60-127 | bits | Strong |
| 128+ | bits | Very Strong |

Hence a typical 6-digit numeric PIN (entropy: 19.9 bits) is considered very weak. A ten digit numeric string, comprising a 4-digit user PIN in combination with a 6-digit numeric PIN (entropy: 33.2 bits) is still considered weak, despite being a relatively long string and therefore difficult to communicate correctly.

It is known that using words as the symbols increases the symbol space notably and therefore allows for strong passwords—or rather pass phrases—which are also memorable. For example, the Diceware methodology, based on a list of 6⁵ =7776 words, generates pass phrases with an entropy of 12.9 bits per word.

According to an aspect of the invention there is provided a method (preferably, performed by an authentication server) of authenticating a request made by a first party of a second party, comprising: receiving from the first party a request and a first symbol string obtained by the first party from the second party, the first symbol string being determined from the request; generating a second symbol string in dependence on the request; authenticating the request of the first party in dependence on the first and second symbol strings.

Preferably, authenticating the request of the first party comprises: comparing and determining the degree of similarity between the first and second symbol strings.

Preferably, the method further comprises authenticating the request when the degree of similarity is determined to be at least 90%, 95%, 99% or more, preferably within a confidence level of at least 90%, 95%, 99% or more, more preferably wherein the first and second symbol strings are determined to be identical.

Preferably, the first symbol string is obtained by the first party from the second party via a voice channel, preferably as spoken words.

Preferably, the method further comprises transmitting information regarding the request to the second party.

Preferably, the information regarding the request is transmitted to the second party by the first party; more preferably, the information further comprises an identifier for the first party; yet more preferably, the identifier for the first party is a temporary identifier for use only for the specific request.

Preferably, the information regarding the request is used by the second party for generating the first symbol string.

Preferably, transmitting information regarding the request to the second party is via a communications channel other than that used for obtaining the first symbol string from the second party by the first party.

Preferably, the method further comprises generating the first symbol string and transmitting said first symbol string to the second party.

Preferably, the method further comprises issuing an authentication token in dependence on authentication of the request; and forwarding the authentication token to an external entity.

Preferably, the authentication token is useable by the external entity in lieu of further authentication of the request.

Preferably, the authentication token is useable only a limited number of times by the external entity, for example only five, four, three, two times or only once, and/or only for a limited time.

Preferably, the first symbol string is useable for authenticating the request only a limited number of times, for example only five, four, three, two times or only once.

Preferably, the first symbol string is useable for authenticating the request only for a limited time.

According to another aspect of the invention thee is provided a method (preferably, performed by a second party, for example a user device such as a smartphone) of authorising a request, comprising: receiving a request from a first party; and transmitting to the first party a symbol string to authorise the request; wherein the symbol string is determined in dependence on the request.

Preferably, the method further comprises generating the symbol string.

Preferably, the method further comprises receiving the symbol string from a third party. Preferably, the symbol strings comprise sequences of words, preferably at least three words.

The words may be selected from a dictionary, wherein the dictionary comprises words which do not have one or more of the following characteristics: a) more than N letters (preferably, where N is 10, 9, 8, 7, 6 or 5); b) fewer than M letters (preferably, where N is 3, 2 or 1); c) are difficult to pronounce or spell; d) sound similar when pronounced to other words in the dictionary; and e) do not relate to a common theme.

Preferably, the first party comprises a merchant or voice assistant, the second party comprises a user or user device such as a smartphone or voice assistant, the third party comprises an authentication server, and the request made by the first party of the second party comprises a request for a service or a payment.

Preferably, the external entity comprises a service provider, payment or account service provider.

According to another aspect of the invention there is provided apparatus for carrying out the method as herein described.

According to another aspect of the invention there is a provided a dictionary assembled according to the method herein described.

Also disclosed is a method of authentication comprising the use of one-time authentication symbol strings, preferably wherein successful authentication results in the issue of a time-based access token.

Preferably the authentication symbols are selected from a dictionary of symbols, preferably an optimised dictionary wherein the component symbols have been selected in dependence on their ease of transmission and/or understanding.

Preferably the authentication symbols comprise words.

Also disclosed is a method of authentication, comprising the generation and comparison of ephemeral candidate word strings to authenticate payments in both online and offline scenarios, using pre-identified time segments, the transaction value and other cryptographic methods to prevent an adversary from equally attempting to guess and generate stings to authenticate unauthorised payments.

These candidate words strings may be for use as a time-based one-time token, authenticating against a separate web-based federation and authentication service, preferably with a limited number of access attempts and more preferably with sufficiently gated or limited access.

In some embodiments, strings of one or more words, each comprising a predetermined, preferably a maximum, number of letters, form a token with reasonable password entropy.

Each token may be calculated separately using different sources of entropy to safeguard against an outside adversary successfully brute-force attacking or generating a single token, whilst all other previous (which will have expired) and subsequent tokens retain their attribute to be computationally difficult to calculate.

The subset dictionary (from which the word strings may be derived) may comprise small, simple words with a limited length, rather than a subset of all words.

Word strings may be used to replace PIN-based authentication for the voice channel.

The word strings may be authenticated by an authentication server or federation service, preferably over a computer network, separate to and away from the voice channel.

A plug-in for an electronic wallet may be used to allow access to bank details for payments.

Preferably, payment cards are each assigned or have determined a seed key to act as a source of entropy for the authentication word string generation algorithm(s).

The invention may provide for an authenticating-only and/or authorising-only payment method.

The authentication and/or authorising may relate to—or be limited to—a specific payment.

Preferably, the authentication server or federation service does not have access to any payment means. Instead, the user request is authenticated by the authentication server on behalf of a third party (a payment provider) which makes the payment. Separating the authentication and payment functions may allow the payment provider to outsource the requirements for meeting authentication regulations.

Authentication and/or authorisation based on word strings as herein described may provide for a more efficient user authentication process as immediate recall is likely greater for a string of words than for a string of random characters. A passcode provided to a user via a smartphone is therefore more onerous for a user to read and recall than would be a word string.

Additionally, input errors may be more easily detected (and optionally corrected) from a mistyped word then from a mistyped passcode.

As used herein:
‘User’ may refer to a person or a user device, such as a smartphone or other computing device such as a laptop, tablet etc. A user may be a person purchasing a service or an item. The terms user and caller may be used interchangeably.
‘Service’ may refer to any service, product, or item, virtual or physical, that a user may wish to access and/or procure.
‘Service provider’ refers to the provider of said service.
‘Agent’ may refer to any intermediary acting as a conduit between the user and the service or service provider. An agent may be associated with a merchant, retailer, or be a contact centre employee representing or acting as an intermediary for the same.
‘Merchant’ may refer to the provider of a service or item for purchase by the user. The terms agent, service provider and agent may be used interchangeably.
Any of the user, agent and merchant may comprise a voice assistant.
‘Transaction’ may refer to any process, not necessarily a monetary one, involving the user. A transaction may refer to a user paying for a service. A transaction may refer to a user attempting to enter an area, either physical or virtual, or a conversation or other interaction between a user and one or more objects or persons.
‘Electronic wallet’ may refer to any virtual storage means, implemented for example as a mobile phone application, for storing sensitive user information such as payment card data, social security information, driving license information and the like. An example of such an ewallet has been previously developed by the applicant (described in international PCT patent application WO2014174322).
‘Channel’ may refer to any communication path between entities over which information can be transmitted. A channel may be a telephone connection, a computer network connection, or a direct interaction between entities, for example using voice (potentially using voice assistants) or gestures.
‘Word’ may refer to a sequence of one or more letters, numbers or symbols, preferably comprising pronounceable syllables, more preferably which have a common or standard pronunciation.
‘Word string’ may refer to any sequence of one or more words.
‘Dictionary’ may refer to any set or collection of words.
A ‘match’ between authentication word strings may refer to a degree of similarity, for example at least or better than 90%, 95%, 99% identical or more, preferably within a confidence level of at least or better than 90%, 95%, 99% or more. Preferably, a match refers to the word strings being determined to be identical.

Further features of the invention are characterised by the dependent claims.

The invention also provides a computer program and a computer program product for carrying out any of the methods described herein, and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein, and/or for embodying any of the apparatus features described herein, a method of transmitting such a signal, and a computer product having an operating system which supports a computer program for carrying out the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied apparatus aspects, and vice versa.

Equally, the invention may comprise any feature as described, whether singly or in any appropriate combination.

Furthermore, features implemented in hardware may generally be implemented in software, and vice versa. Any reference to software and hardware features herein should be construed accordingly.

The invention will now be described, purely by way of example, with reference to the accompanying drawings, in which:

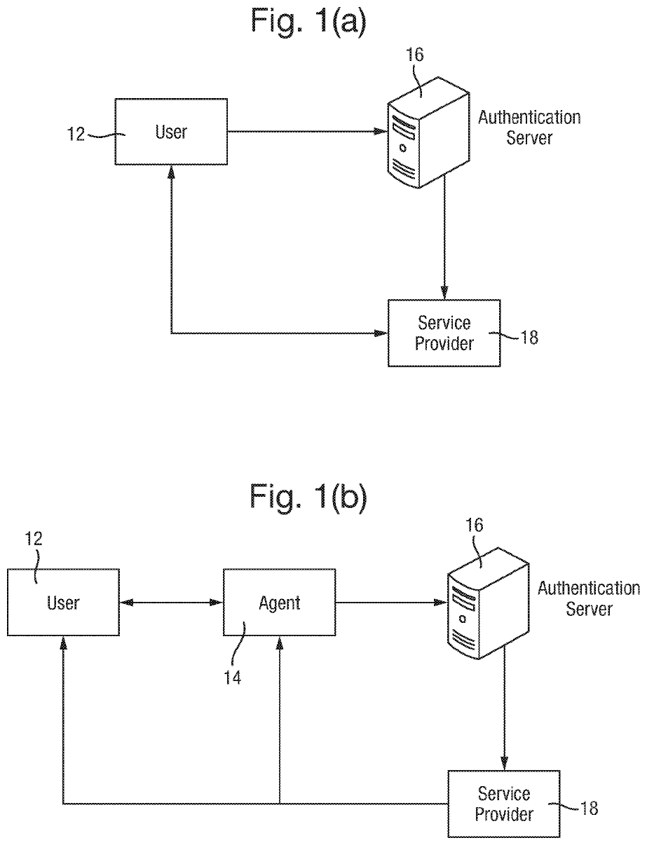

FIG. 1 shows an authentication system in overview;

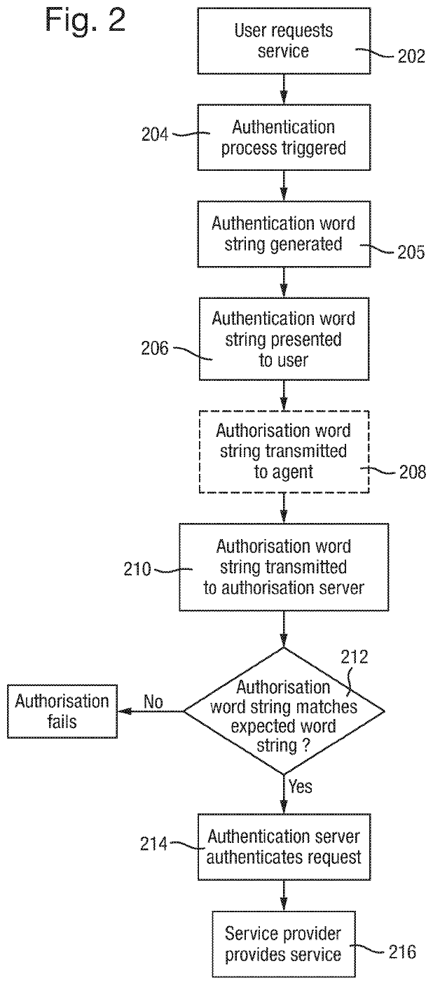

FIG. 2 shows an authentication process in broad overview;

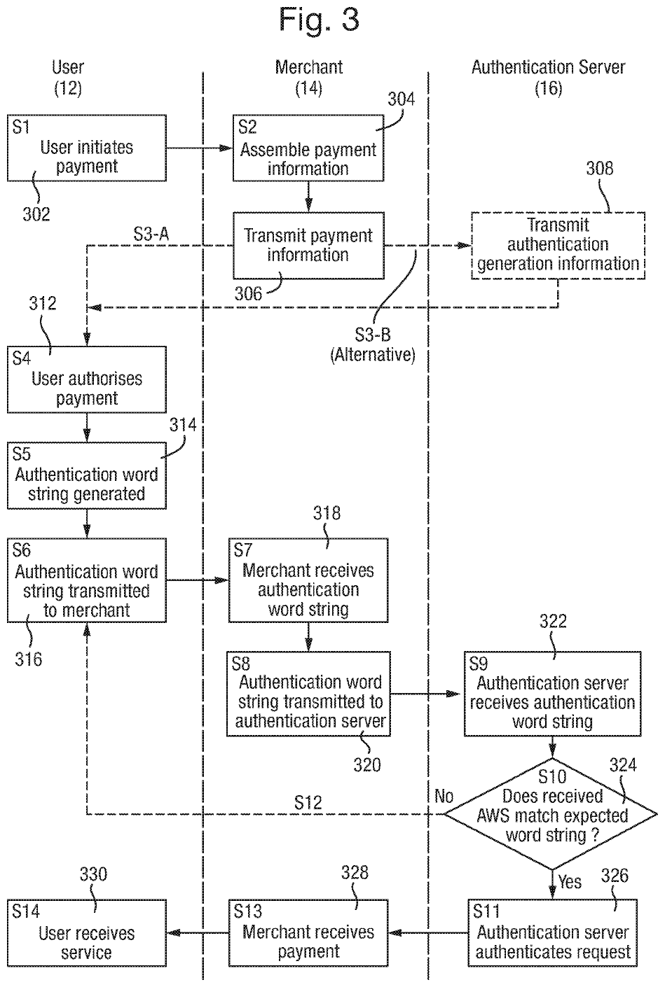

FIG. 3 shows an authentication process used to authorise a payment transaction;

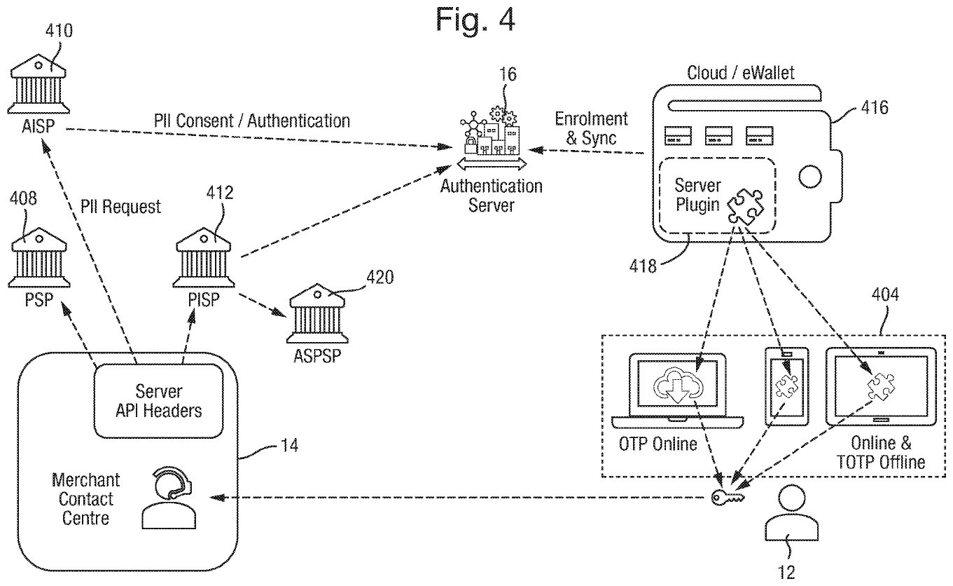

FIG. 4 shows a payment system infrastructure for use with the authentication/authorisation process;

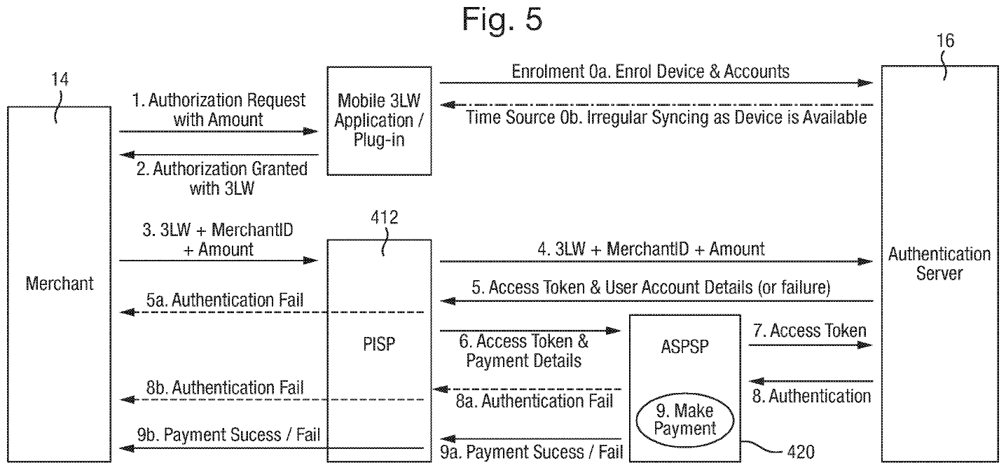

FIGS. 5 to 7 are overview sequence diagrams;

FIG. 5 is an overview sequence diagram for a payment using the authentication/authorisation process;

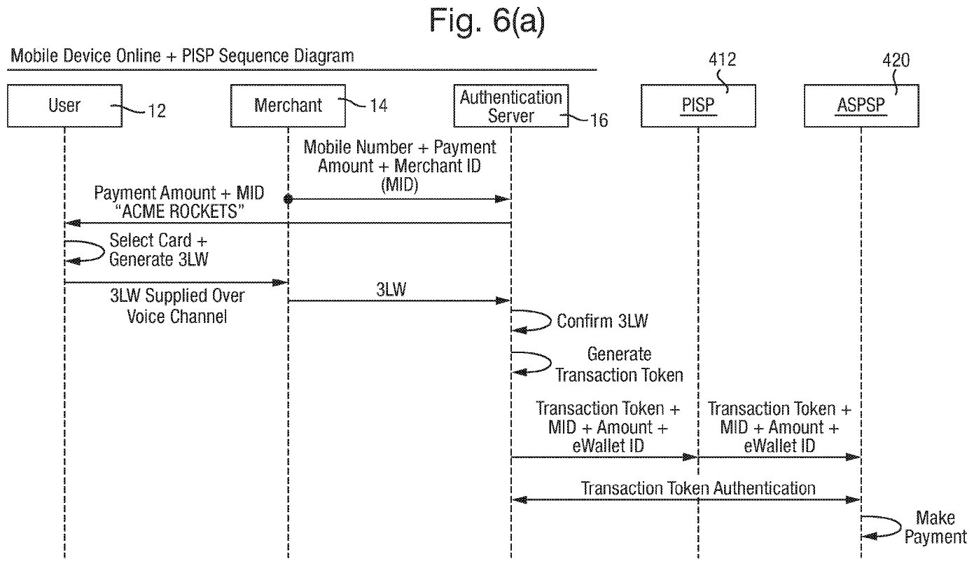

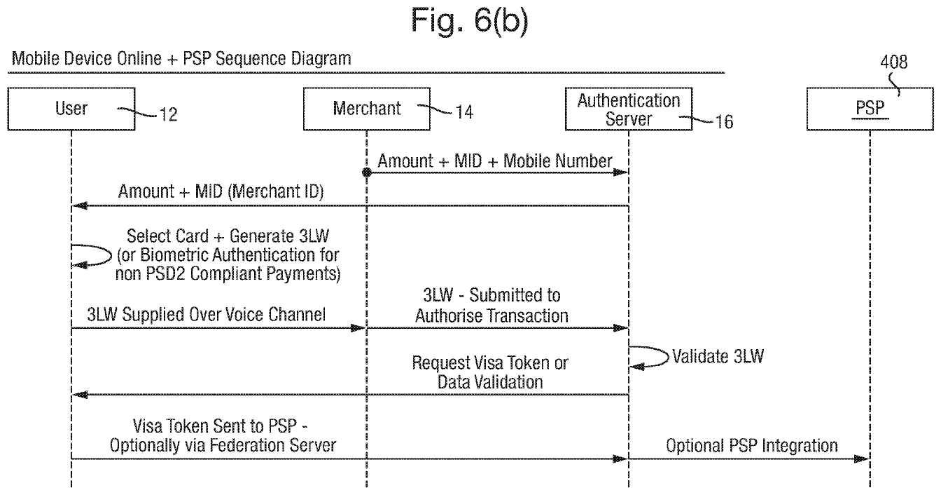

FIGS. 6 are basic sequence diagrams for online payment;

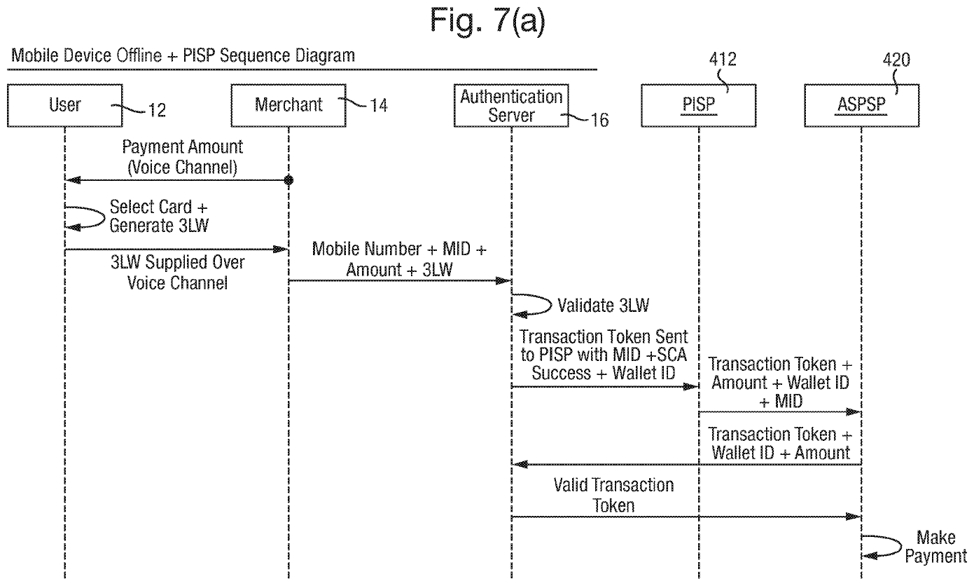

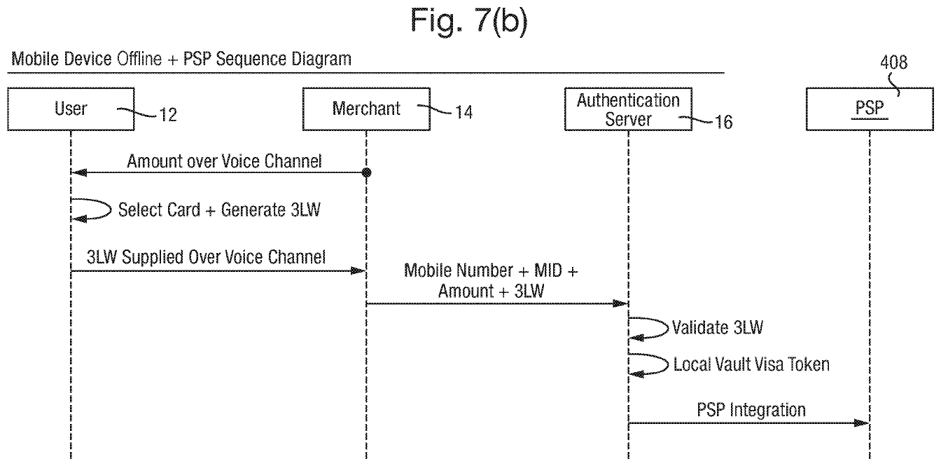

FIGS. 7 are basic sequence diagrams for offline payment;

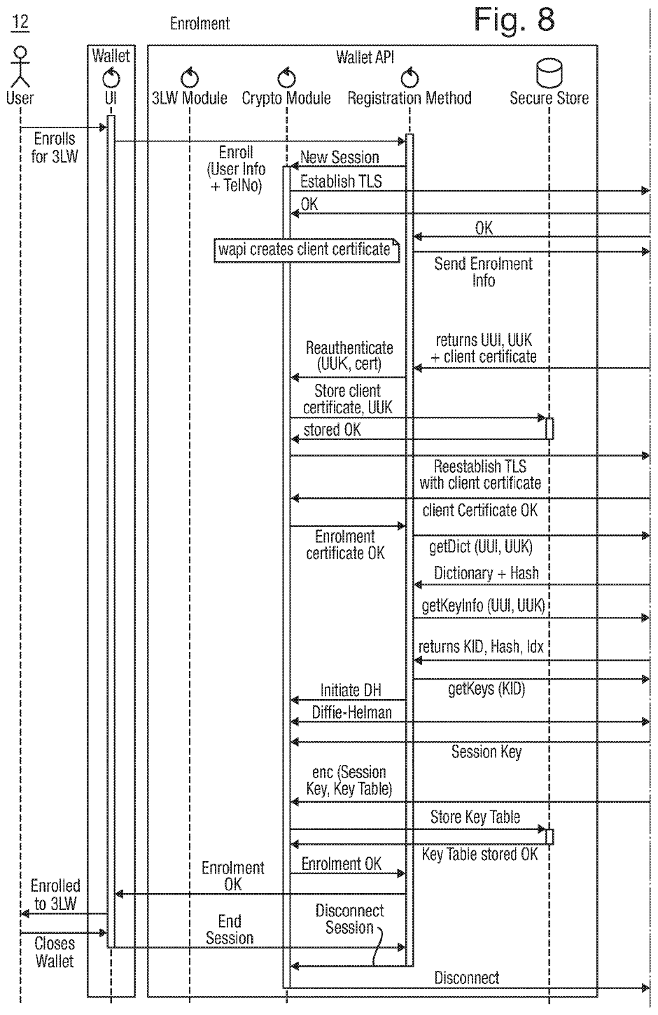

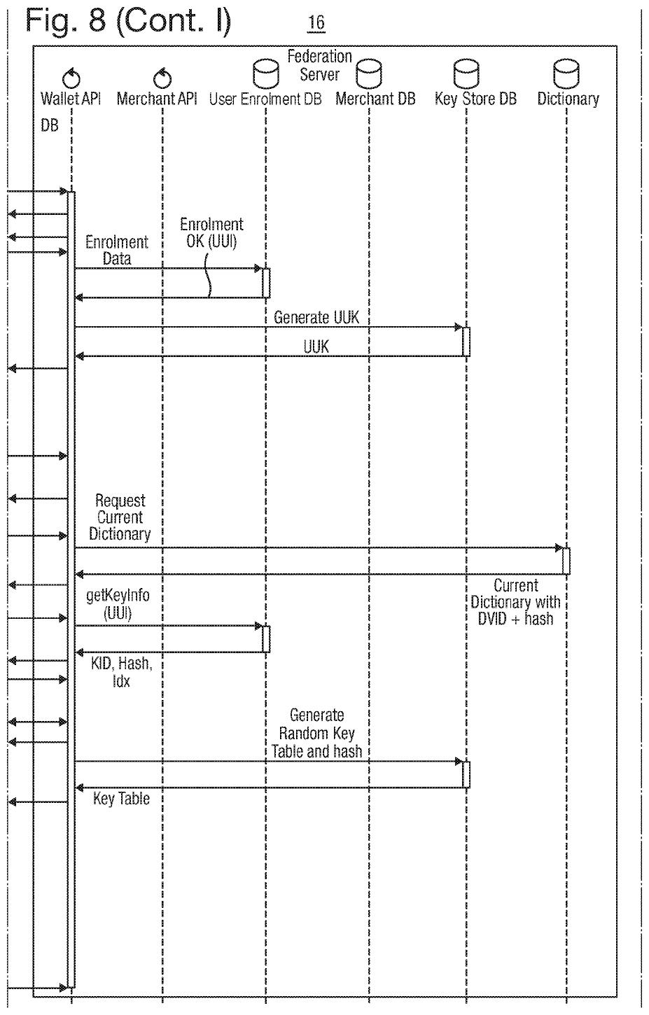

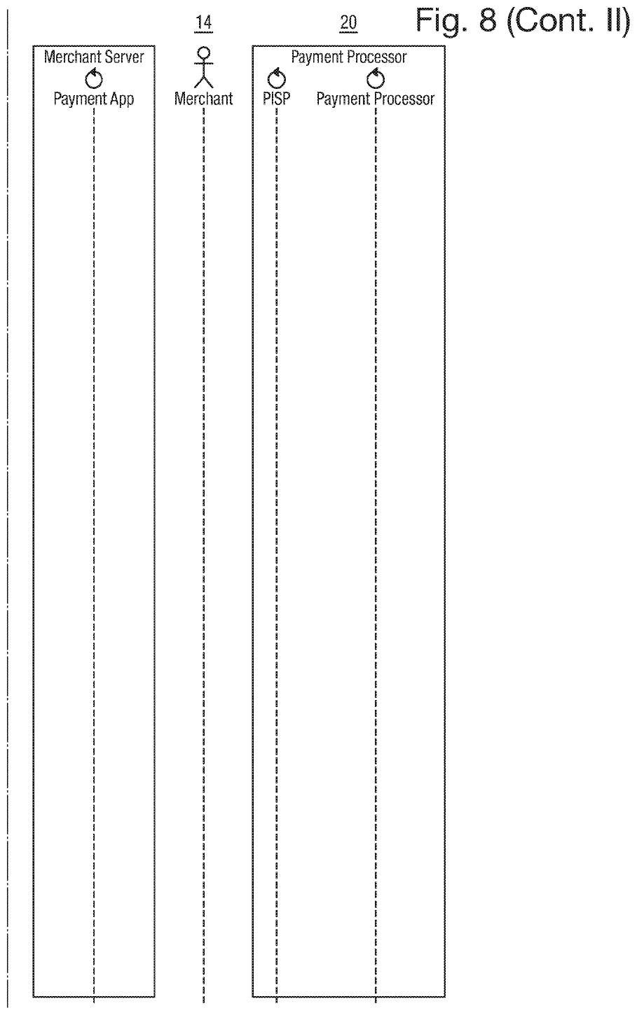

FIGS. 8 to 11 are detailed sequence diagrams;

FIG. 8 is a detailed sequence diagram for user enrolment;

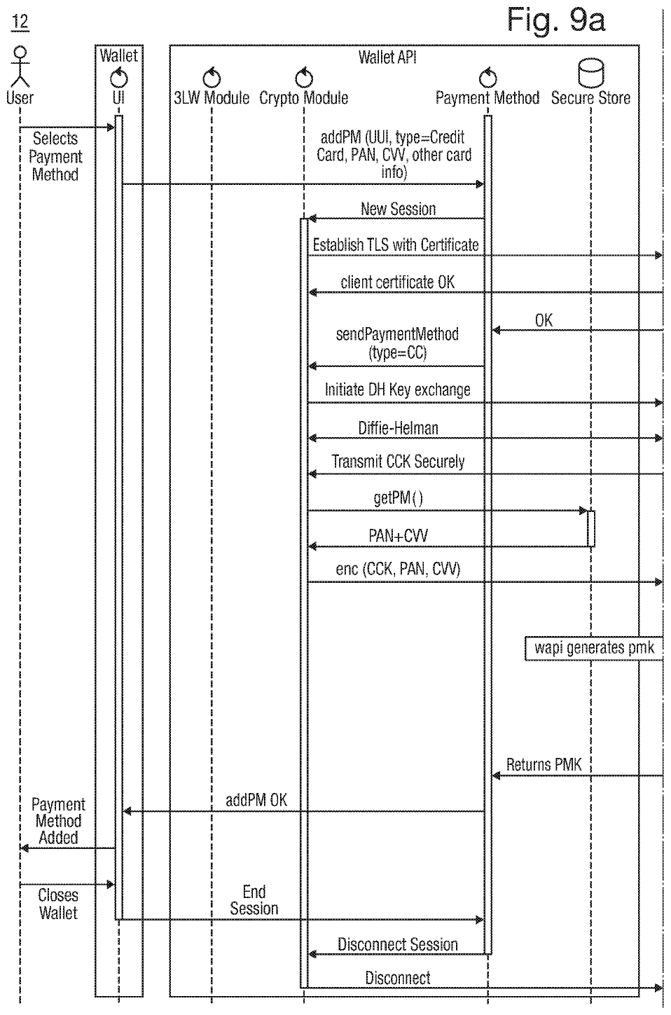

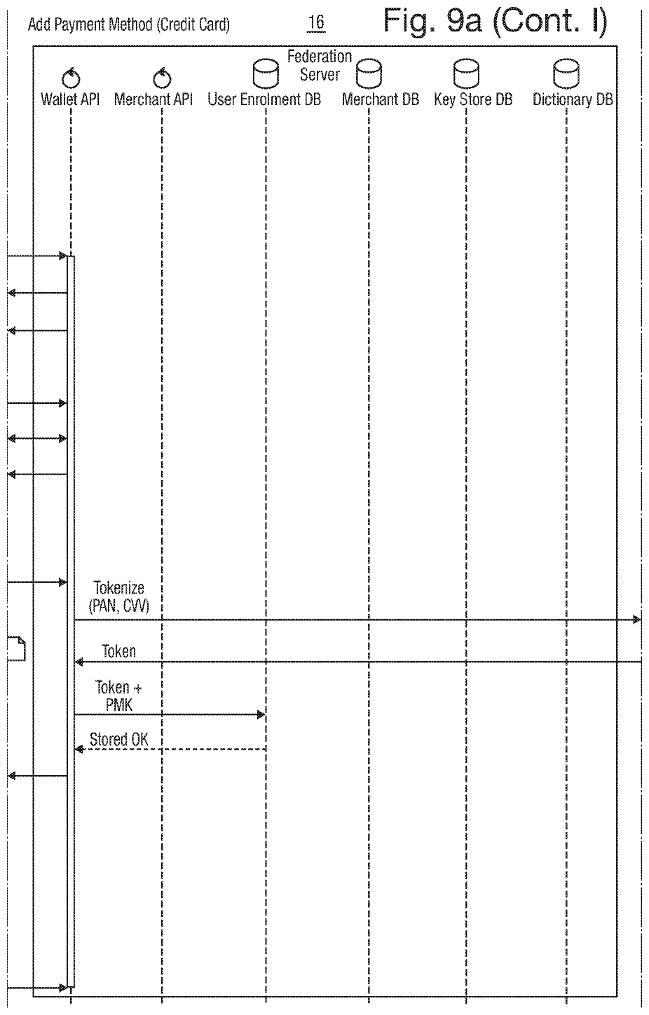

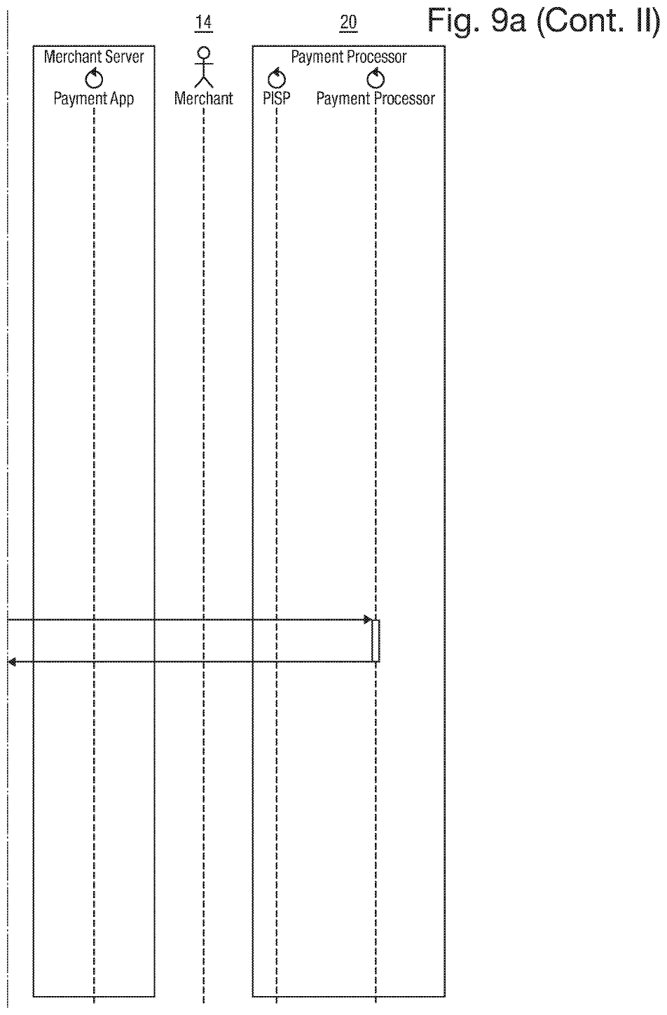

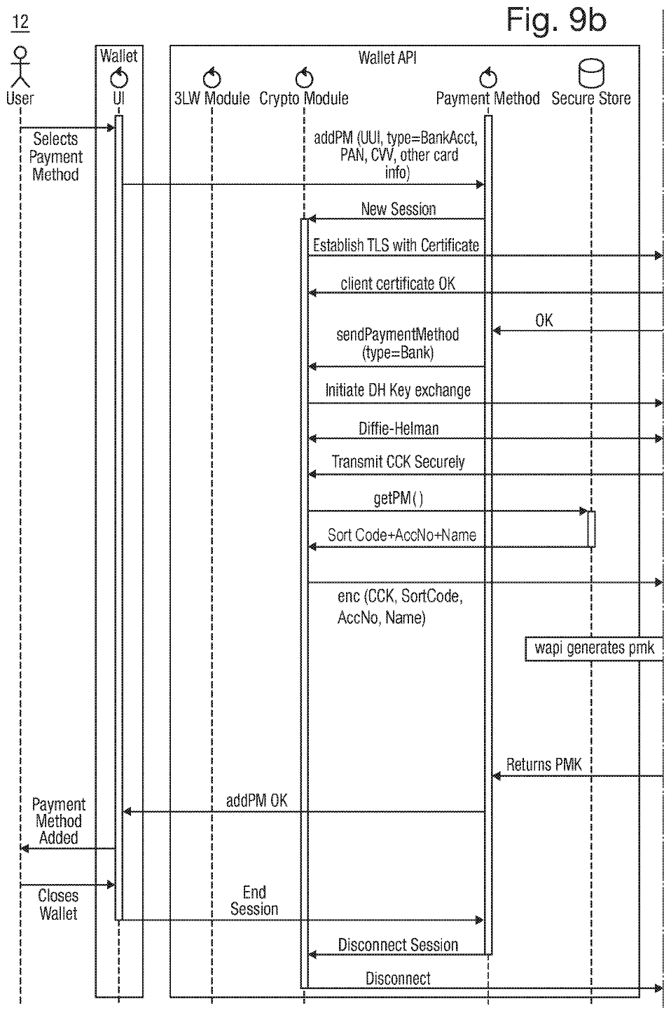

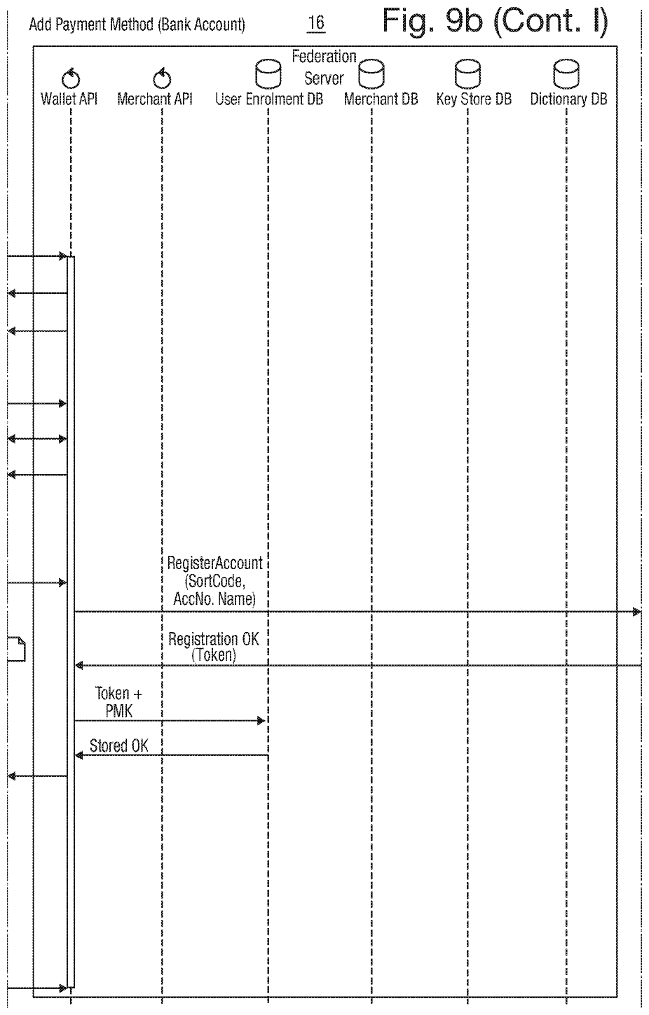

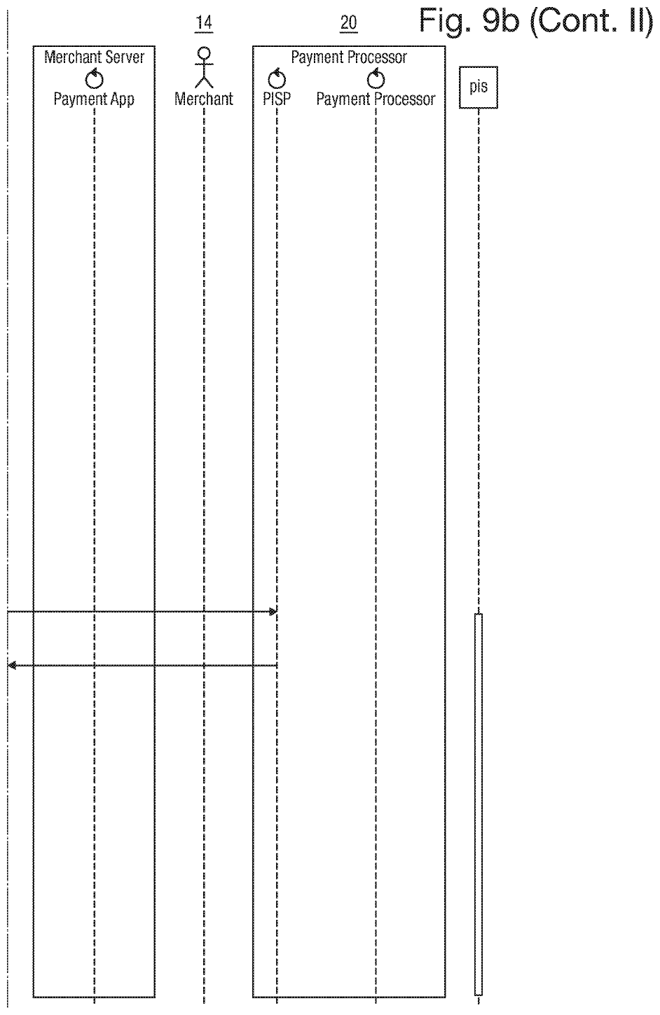

FIG. 9 are detailed sequence diagrams for registering payment means/methods with the authentication server;

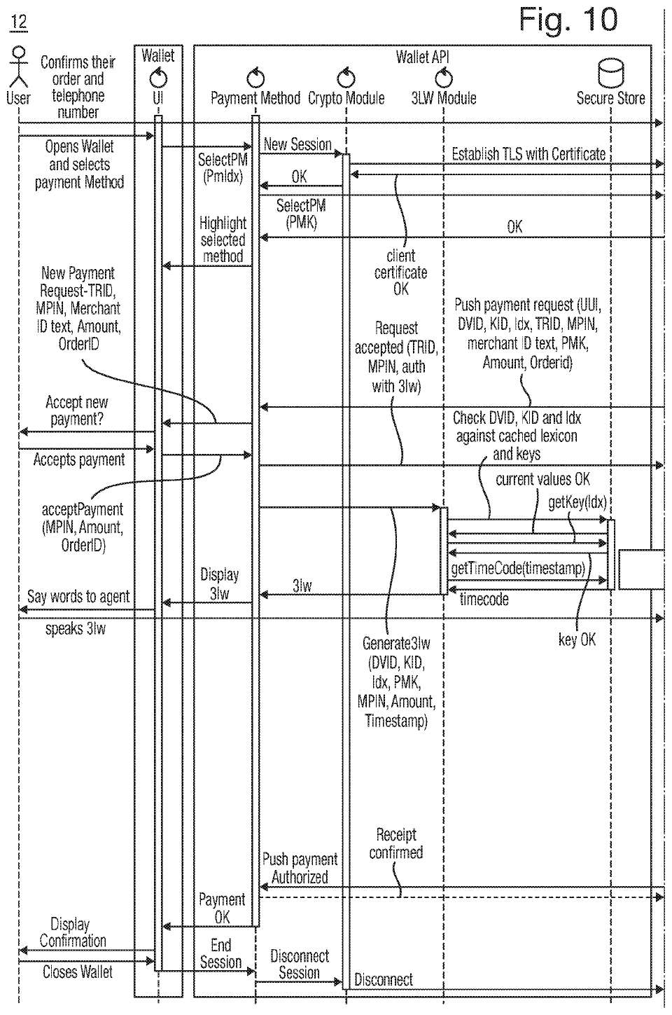

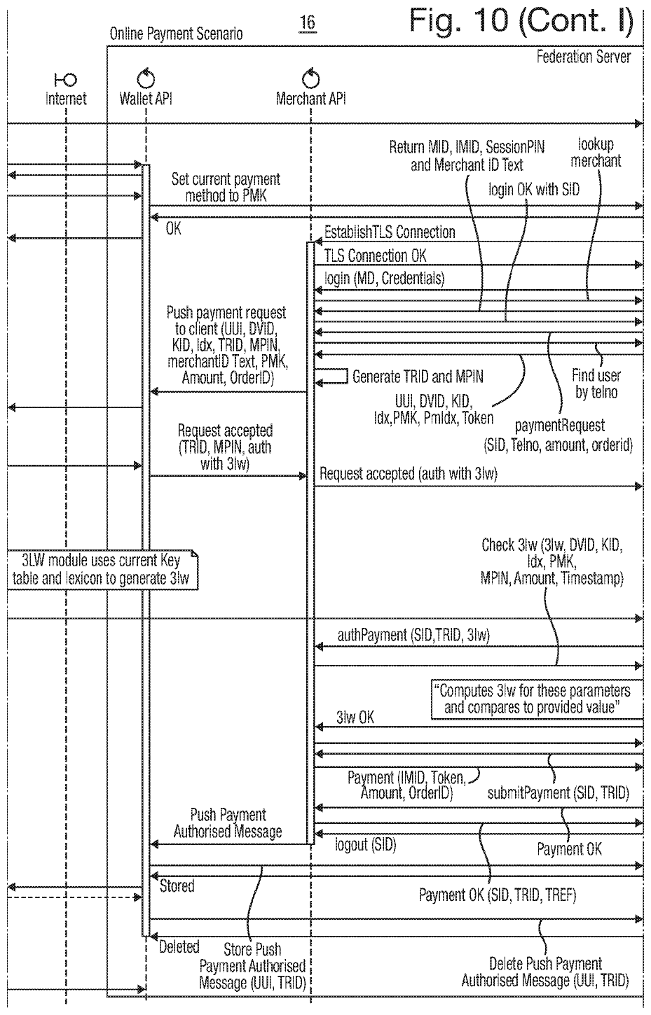

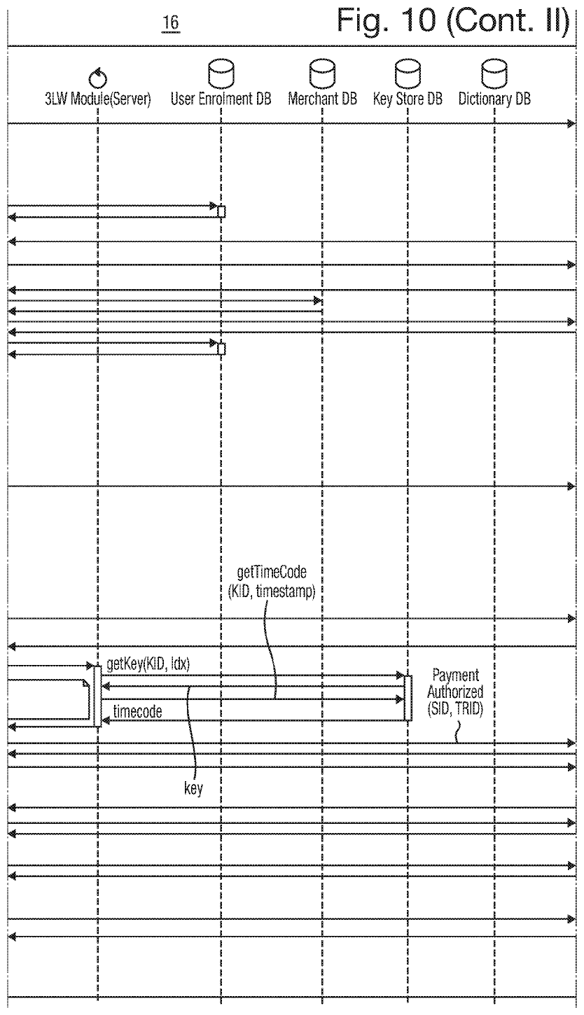

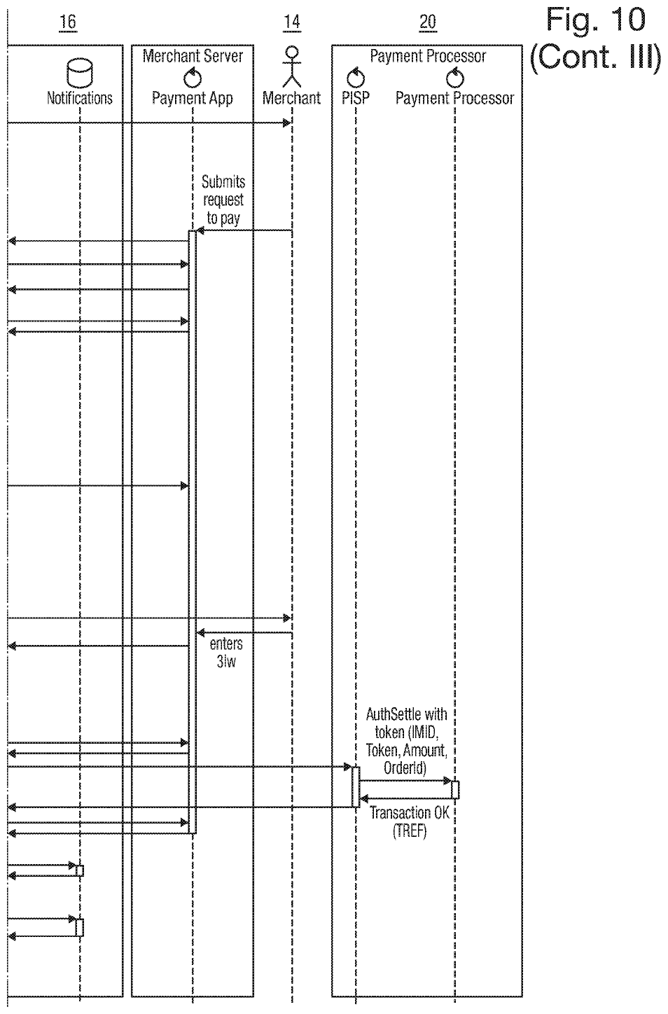

FIG. 10 is a detailed sequence diagram for online payment;

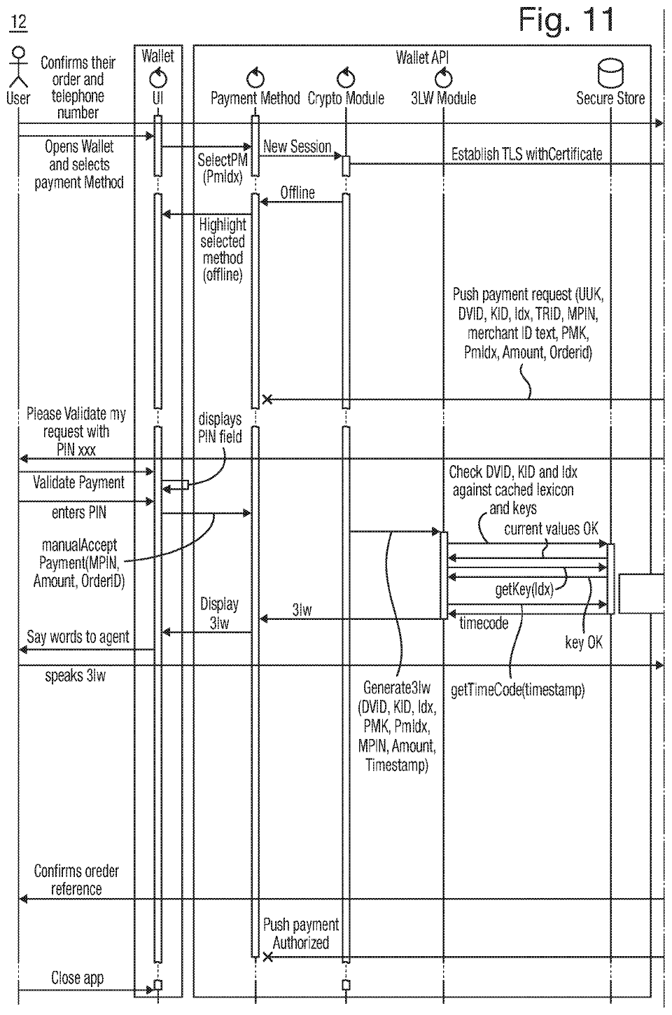

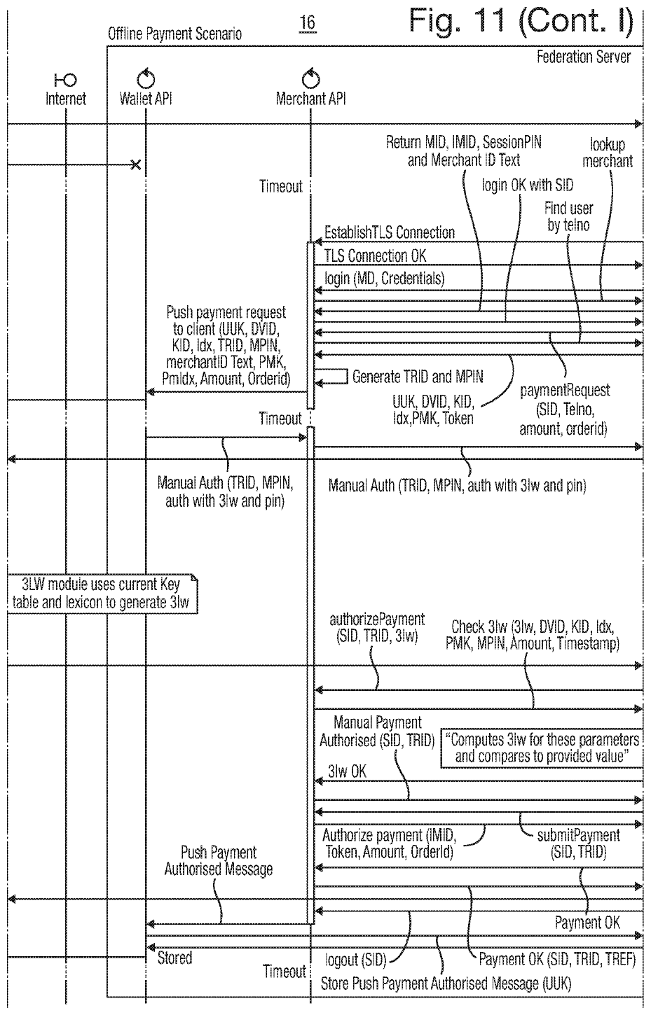

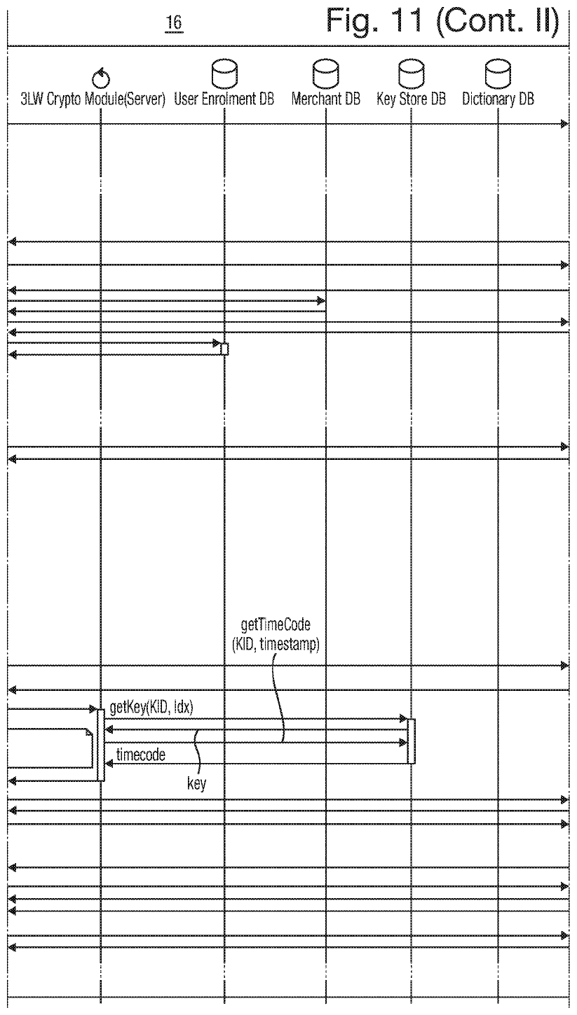

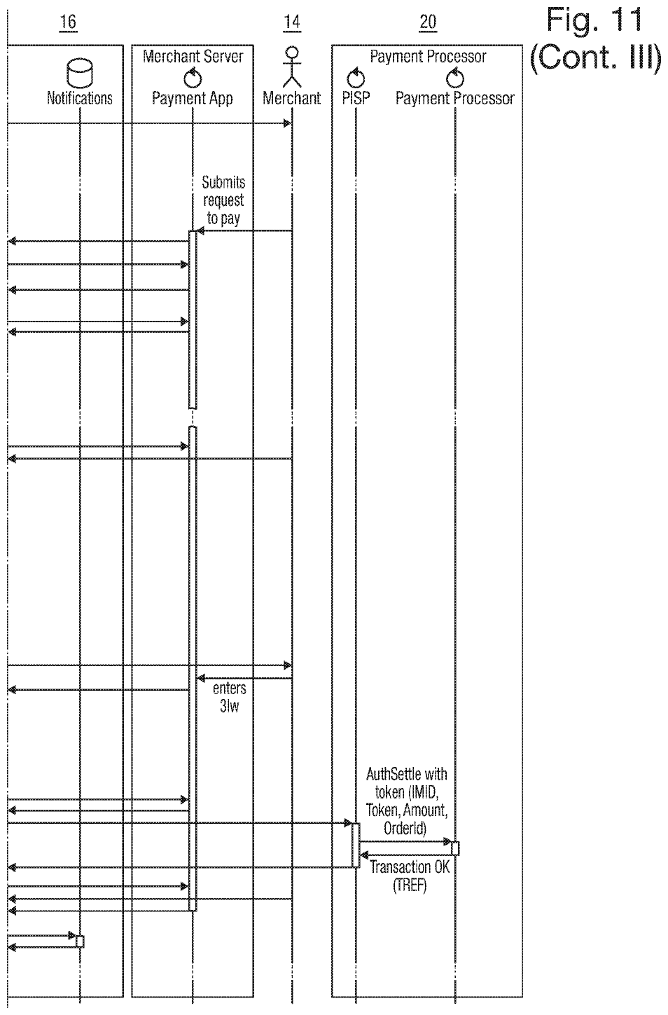

FIG. 11 is a detailed sequence diagram for offline payment;

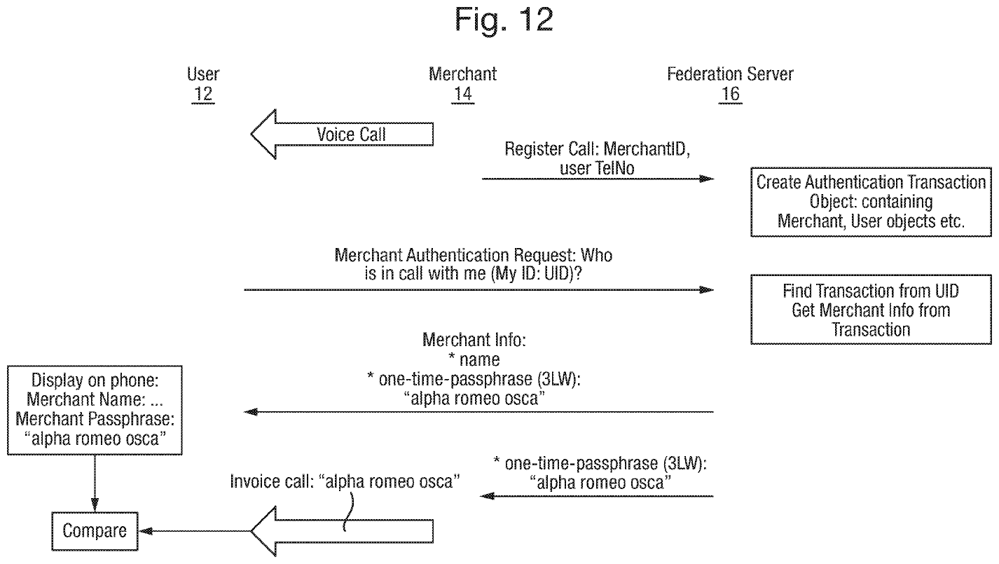

FIG. 12 is a sequence diagram for merchant authentication;

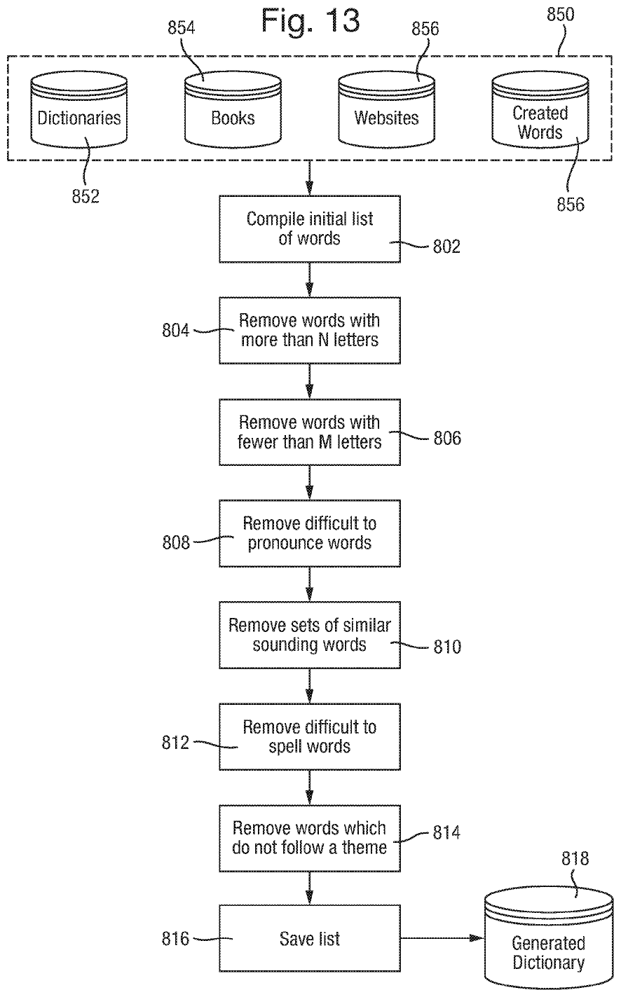

FIG. 13 shows a process for creating an authentication dictionary;

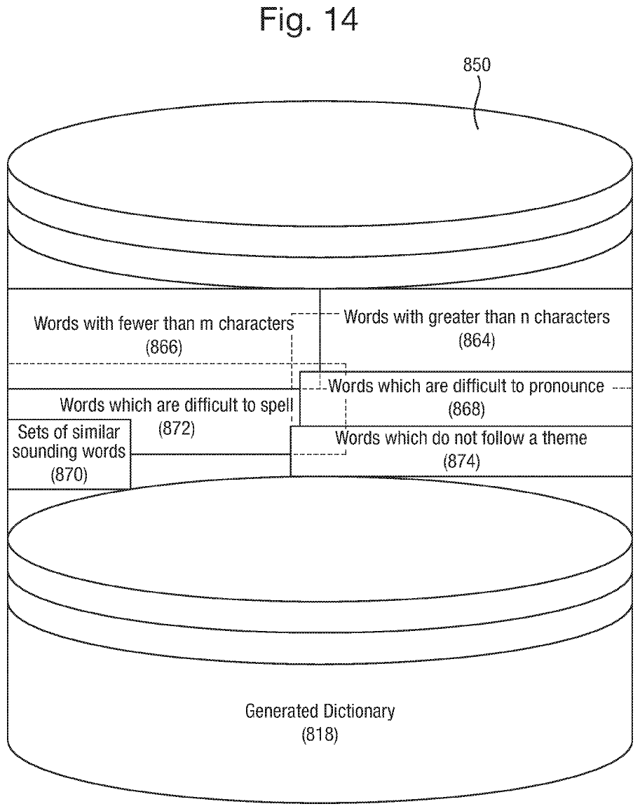

FIG. 14 is a schematic of an authentication dictionary;

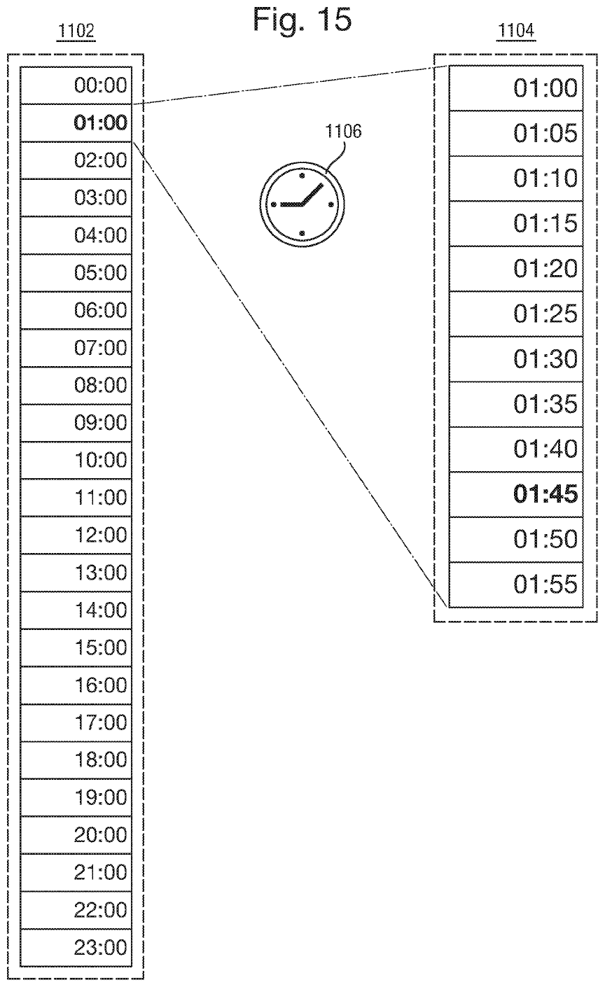

FIG. 15 shows a method of time-based word generation;

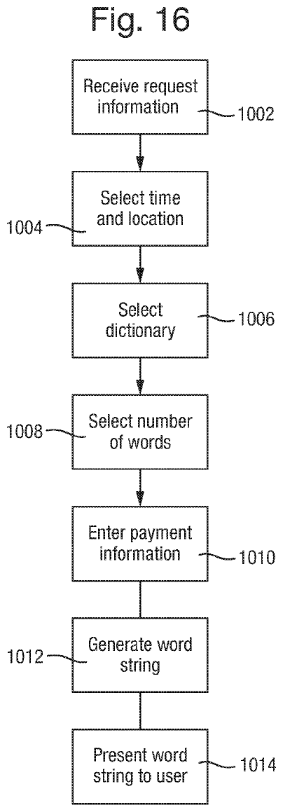

FIG. 16 shows a method of processing he authentication word string; and

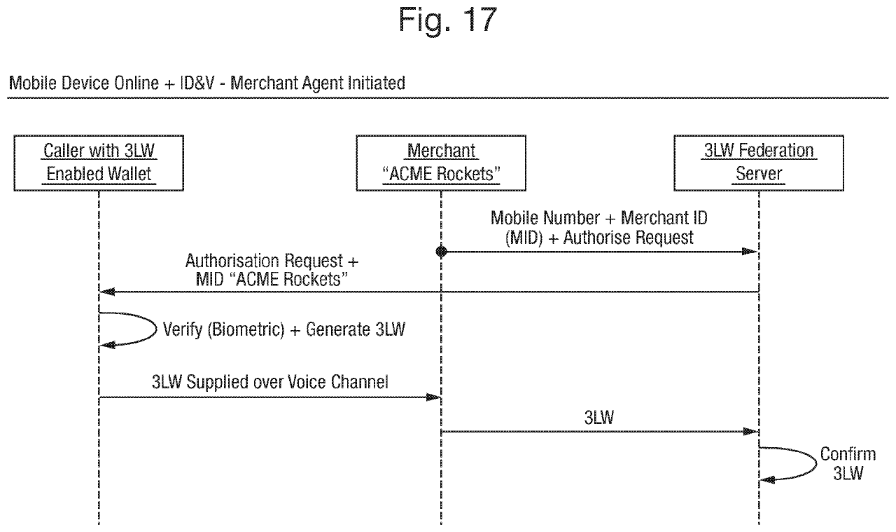

FIG. 17 shows use of the authentication process in Identification & Verification.

### OVERVIEW

FIG. 1 shows an authentication system in overview, wherein a user 12 is in communication with a service provider 18 and both are in communication with an authentication server 16.

In use, service provider 18 will only provide a requested service to user 12 if a valid user authentication is provided by the authentication server 16.

FIG. 1b shows a variant of the authentication system, wherein an agent 14 acts as an intermediary between the user 12 and the service provider 18. User 12 and agent 14 may be in communication verbally, for example via a telephone connection. The service provider 18 may provide a service to either the user 12 directly, via the agent 14, or to the agent 14 on behalf of the user.

In some embodiments, the agent 14 may be replaced by an interactive voice response (IVR) system and/or the authentication server 16 equipped with speech or voice recognition capability in order to determine words spoken by the user.

Generally, the authentication process comprises the generation of an authentication word string (AWS), the component words selected from an authentication dictionary (AD) in dependence on features of the request, and the user 12 transmitting the authentication word string to the authentication server 16 either directly or via the agent 14. Authentication server 16 then attempts to authenticate the user on the basis of the received authentication word string AWS by comparison with an expected word string (EWS) and, if the match is successful, sends an authentication confirmation message or service request message directly to the service provider 18 and/or via the agent 14 to confirm that the request is legitimate and that the service may be provided to the user 12.

Typically, for many practical applications, the authentication word string (AWS) may comprise three relatively short words, hence may be referred to as “three little words” (3LW).

In some embodiments, as described below, successful authentication results in the generation of an access token (T), preferably time-limited, which is then used in lieu of further authentication.

A typical implementation of the authentication system comprises a user with a device such as a smartphone or a voice assistant, in voice communication with an agent at a contact centre, the agent having access to an authorisation interface of the authorisation server, the smartphone having installed a software application for generating the authentication word string. The skilled person will appreciate many other possible embodiments making use of aspects of the authentication process, some of which are discussed in the following.

In some embodiments, the authentication system is used for reverse-authentication, whereby for example the merchant seeks to authenticate with the caller. This is described in detail later in this document.

FIG. 2 shows an authentication process in broad overview, which generally proceeds via the following sequence of steps:
S1. The user requests 202 (optionally, via an agent if in communication with one, say via a telephone call) a service from a service provider.
S2. The authentication process is triggered 204 by the user directly by invoking an authentication application on the smartphone, indirectly by say accessing an electronic wallet, or triggered remotely by the service provider (or the agent), thereby requesting generation of an authentication word string (AWS).
S3. An authentication word string is generated 205, which involves selection by algorithm of one or more words from an authentication dictionary, preferably stored on the smartphone.
In some embodiments, a word may be selected for the authentication word string only once, such that the authentication word string comprises a series of unique or non-identical words. In other embodiments a word may be selected more than once, such that the word may occur more than once in the authentication word string.
S4. The authentication word string is presented 206 to the user via the smartphone screen.
S5. (Optionally, the authentication word string is transmitted to the agent 208, which may involve the user simply speaking the authentication word string to the agent).
S6. The authentication word string is transmitted 210 (optionally, by the agent) to the authentication server.
S7. At the authentication server, the received authentication word string (AWS) is compared to an expected word string (EWS), which is generated using the same algorithm and an identical authentication dictionary (AD) as was used for generating the authentication word string.
S8. If the received authentication word string matches the expected word string, the authentication server authenticates 214 the request. An authentication token (T) is sent to the service provider to provide 216 the requested service.
S9. If the received authentication word string (AWS) does not match the expected word string (EWS), the authentication fails. The system may allow a repeat attempt at authentication which may in turn require the generation of a new authentication word string (AWS₂).

Variations on the above are described below, as are processes for generating the authentication dictionary and the authentication word string.

This method may be used as part of a multi factor authentication (MFA) process, where the use of this method constitutes one factor, ie. proof of possession of a particular smartphone. Additional factors may be provided as part of the authentication process, for example requiring the user to provide a password or a biometric such as a thumbprint in order to generate an authentication word string.

This method may also be used to provide out-of-band authentication (OOBA), whereby the authentication channel (eg. a spoken voice telephone channel) is separate from the channel used for transmitting the sensitive information (eg. a computer network data channel).

FIG. 3 shows an authentication process used to authorise a payment transaction, wherein a user 12 is seeking to make a payment to a merchant 14 using authentication server 16, which proceeds via the following sequence of steps:
S1. The user 12 initiates the payment process, for example by voice instruction to the merchant 14.
S2. Payment information, such as a payment amount and a merchant identifier (MID, which may optionally comprise additional data such as a time and location), is assembled 304 by the merchant.
In scenarios where the smartphone is offline, or for reverse-authentication scenarios, the federation service generates a one-time merchant identifier MPIN which may be passed via the voice channel to the smartphone to be used to generate an authentication word string. This is described in more detail below.
S3. EITHER
A) The merchant 14 transmits 306 the payment information directly to the user. This alternative may be used if the user 12 does not have network connectivity or is otherwise unable to connect to the authentication server.
This payment information may be combined with a temporary PIN provided by the authentication server.
In some embodiments, the user may receive the payment information from the merchant 14 via a short-range data transmission protocol such as Bluetooth or NFC.
OR
B) Alternatively, the merchant transmits the payment information to the authentication server 16 which it turn transmits 308 the payment information to the user 12. In other words, the user does not receive the payment information from the merchant directly but rather from the authentication server 16.
This may provide a trusted record at the authentication server of the transaction for non-repudiation purposes, ie. requiring each party to the transaction to separately communicate with the authentication server 16 provides evidence that each party individually approved the transaction.
The outlined protocol also supports the addition of a User or Merchant-selected transaction PIN “TPIN”, composed of 4 to 8 decimal digits, which may be randomly or pseudo-randomly generated, to introduce more symmetry into the protocol as required
It is possible to integrate the exchange of the TPIN into the existing protocol flow. There are two options to do so.
The first is to let the User read the TPIN out to the Service's agent at the same time as the 3LW token.
Another possibility is to include this exchange very early on, for example as part of the initial agreement to engage in a 3LW-backed confirmation. This may require an additional voice-based interaction, but leaves the communication of the 3LW token as simple as in the original concept.
In some embodiments, the merchant 14 and authentication server 16 are not in direct communication but instead communicate via an intermediary.
S4. The user 12, if in agreement, authorises 312 the payment.
The user 12 may be required to enter at least a part of the payment information manually in order to confirm one or more of the amount, service, merchant etc.
Confirmation may comprise the user selecting payment means such as a payment service or a payment card from an electronic wallet—or any other means of payment preferably previously registered with the authentication server. In some embodiments, a payment method may be selected based upon past preferences. The selection may be pre-selected prior to initiation of the payment process.
If the user has received the payment information directly from the authentication server no further confirmation may be required.
S5. An authentication word string (AWS) is generated in dependence on the payment information and, where provided, other information such as that provided by the authentication server 16. This authentication word string is presented to the user.
Additional authentication actions may be required of the user before the authentication word string is generated, for example provision of a passcode or biometric.
S6. The user 12 transmits 316 the authentication word string (AWS) to the merchant 14. For a telephone or face-to-face interaction with the merchant the user may simply speak aloud the authentication word string.
S7. The merchant receives 318 the authentication word string.
S8. The merchant transmits 320 the authentication word string to the authentication server 16.
S9. The word string is received 322 by the authentication server.
S10. The authentication server compares 234 the received authentication word string (AWS) the to the expected word string (EWS), generated using the same algorithm and from the same authentication dictionary as the authentication word string.
S11. If the authentication word string (AWS) received by the authentication server matches the expected word string (EWS) 324 the authentication server authenticates 326 the payment request and the authentication is considered successful.
S12. If the authentication word string received by the authentication server does not match the expected word string 324 the authentication fails.
There may be an option to retry the authentication either with the same authentication word string (effectively, AWS₁,) or a newly generated one (AWS₂). The number of authentication retries may be limited, after which a generated authentication word string may no longer be used for authentication. There may be a limit to the number of authentication word strings which may be generated for an attempted payment. The number of attempts permitted may depend on the degree of matching between the authorisation and expected word strings, or on the type of discrepancy detected.
An alert may be generated when unexpected words are received by the authentication server, preferably when a maximum number of attempts is exceed. This alert may be a message sent to the user, which may act as a warning that a request has been made in their name. An alert may also be sent to a third party. This alert may comprise an action, such as locking of a payment method, so that it cannot be used until a separate authentication action is performed.
S13. If the payment request is authenticated, the payment is processed (for example by a payment processor) and payment is received 328 by the merchant.
S14. The user receives 330 the requested service.

More detailed variants which make use of the authentication process are described below.

FIG. 4 shows a payment system infrastructure for use with the authentication/authorisation process, in particular showing how various user computing devices 404 (laptop, smartphone, tablet etc), merchant contact centre 14 and authentication server 16 are integrated with standard payment entities, including:
Payment Service Provider (PSP) 408
Account Information Service Provider (AISP) 410
Payment Initiation Service Provider (PISP) 412
Account Servicing Payment Service Provider (ASPSP) 420.

As shown, user 12 makes use of an electronic wallet (eWallet) 416 for making payments and storing personally identifiable information. The eWallet may be stored remotely, ie. in the ‘cloud’.

The authentication process is governed by software application which may be provided locally at the user computing devices 404 and/or remotely eg. integrated with the eWallet software, for example as a plugin 418.

The user 12 may have both online and offline options for providing authentication to the merchant contact centre 14, depending on the particulars of the payment and availability or otherwise of a network connection.

### Overview Sequence Diagrams

FIGS. 5 to 7 are overview sequence diagrams.

FIG. 5 is an overview sequence diagram for a payment using the authentication/authorisation process.

Interactions are shown between the merchant 14, a Payment Initiation Service Provider (PISP) 412, an Account Servicing Payment Service Provider (ASPSP) 420, and the authentication server 16.

In this embodiment, the merchant does not communicate directly with the authentication server. Instead, user authentication is provided to the PISP, which in turn authorises an ASPSP to make a payment to a merchant.
0) a. Enrol Device & Accounts
The user device and associated payment details are registered with the authentication server.
b. Time Source-Irregular Syncing as Device is Available
Where the authentication word string is time dependent, some initial synchronisation of user device and authentication server is required. As described in more detail below, the embodiments of the authentication system allow for subsequent synchronisation being irregular depending on network availability.
1) Authorization Request with Amount
The merchant requests the user to make a payment of a certain amount.
2) Authorization Granted with AWS (3LW)
The user, having confirmed the amount, generates an authentication word string in dependence on a merchant identifier (MID) and the payment amount, ie. the MID and amount are encoded in the authentication word string. In some embodiments details of the payment method to be used (for example, part of the payment card details) may also be encoded in the authentication word string.
As mentioned previously, the MID may be a one-time or temporary merchant identifier MP IN, generated by the authentication server.
The user speaks the authentication word string to the merchant 14.
3) AWS (3LW)+MerchantID+Amount
The authentication word string received by the merchant 14 is transmitted, via a computer network, to a PISP 412.
In some embodiments the merchant identifier MID and/or the payment amount is transmitted separately.
4) AWS (3LW)+MerchantID+Amount
The PISP transmits this authentication word string, merchant identifier and amount to the authentication server 16.
As the calculation of the AWS is dependent on the amount and merchant identifier MID, the authentication server will generate, compare, and authenticate an identical AWS even if the user is offline.
5) Access Token & User Account Details (or Failure)
If the authentication server 16 determines the received authentication word string is correct, it generates an access token (T), indicating that the user has been authenticated, and issues it to the PISP.
Also transmitted are user account details, so that the PISP may check that the payment means being requested are authorised to be used by the user.
The access token (T) received by the PISP therefore incorporates:
   the Merchant ID
   User details
   Amount
   Two-factor authentication (2FA) from two separate channels, voice (via the authentication word string spoken by user to the merchant) and online (from the response of the authentication server, separately generating an AWS, comparing it with the one received from the merchant and confirming or otherwise)
If the authentication word string received by the authentication server 16 is not the expected word string a failure notification is returned to the PISP 412 . . .
5a. Authentication Fail
. . . and then to the merchant 14.
6) Access Token & Payment Details
The PISP 412 transmits the access token (T) received from the authentication server 16 to the ASPSP 420 along with payment details for the user.
The authorisation server 16 only accepts access tokens from the ASPSP 420, specifically not from the merchant 14, thereby preventing the merchant 14 authorising the actual payment stages.
7) Access Token
The ASPSP transmits the access token (T) to the authentication server 16 where it is compared the original token (T₀) to what was originally transmitted to the PISP thereby ensuring that the PISP was not sent a ‘false’ token by a malicious third party.
In some embodiments the access token (T) is digitally signed or otherwise modified by the PISP and/or the ASPSP to provide a further layer of security and/or traceability.
8) Authentication
If the access token (T) received by the authentication server from the ASPSP matches that (T₀) sent from the authentication server to the PISP, an authentication success message is sent from the authentication server to the ASPSP
If the access token received by the authentication server from the ASPSP does not match the token (T₀) sent by the authentication server to the PISP, an authentication failure notification is generated (which is sent from the authentication server to the ASPSP . . .
a. Authentication Fail
. . . and from the ASPSP to the PISP.

b. Authentication Fail
. . . and from the PISP to the merchant 14.
9) Make payment
Upon receipt of an authentication success message by the ASPSP, payment is attempted . . .
a. Payment Success/Fail
. . . and a success/failure message is sent from the ASPSP to the PISP . . .
b. Payment Success/Fail
. . . and from the PISP to the merchant 14.
Further variants of online/offline authentication and payment are provided below.

### Online Payments

FIG. 6 are basic sequence diagrams for online payment, wherein the user device is able to communicate with the authentication server 16 during the transaction.

In these online examples, as previously described, the payment request from the merchant 14 is routed via the authentication server 16. The authentication server 16 sends payment details together with a merchant identifier MID to the user 12 who, presumably being agreeable to making the payment, selects a payment method (such as a payment card from an eWallet, providing local authentication if required), generates an authorisation word string (AWS/3LW), and provides it over the voice channel to the merchant 14, who forwards it (preferably over a computer network rather than via voice) to the authentication server 16 for validation/confirmation by comparison with an expected word string EWS.

FIG. 6a shows an example of online authentication with a PISP 412 and ASPSP 420, similar to that shown previously, wherein a transaction token (T_{T}) is generated by the authentication server 16 and forwarded to the PISP 412 for use when in turn authorising the ASPSP 420 to make the payment (to a merchant identified by the MID, for the specified amount, from an identified eWallet of the user), preferably each in turn separately authenticating the token (T_{T}) with the authentication server 16.

FIG. 6b shows an example of online authentication integrated with a PSP 408, wherein the authentication server 16 subsequently, rather than issue a transaction token (T_{T}) itself, requests a secondary or validation token (Tᵥ) from the user 12 for forwarding as authentication to the PSP.

A potential advantage for PSP transactions is that use of AWS authentication may allow for separation of the data used to authorise payment between different channels (voice and data) as required by some financial regulations.

### Offline Payments

FIG. 7 are basic sequence diagrams for offline payment, wherein the user 12 device may not have network connectivity and is thus unable to communicate during the transaction with the authentication server 16.

The user 12 will previously have registered a payment method with the authorisation server.

The user 12, who is presumably agreeable to making the payment, selects a payment method (such as a card from an eWallet, providing local authentication if required), enters the merchant identifier (MID) and payment amount, thereby generating an authorisation word string AWS/3LW, and provides the AWS/3LW over the voice channel to the merchant 14, who forwards it (along with the user phone number, MID and amount, preferably over a computer network rather than via voice) to the authentication server 16 for validation/confirmation by comparison of the AWS/3LW with the expected word string EWS.

FIG. 7a shows an example of offline authentication with a PISP and ASPSP, similar to that shown previously, wherein an access token is generated by the authentication server and forwarded to the PISP for use when authorising the ASPSP to make the payment.

A strong customer authentication (SCA) success notification, indicating that multi factor authentication (MFA) over multiple separate channels has been used, may also be transmitted by the authentication server 16 to the PISP 412. Such a success notification would indicate to the PISP a measure of the security of the authentication means used.

FIG. 7b shows an example of offline authentication integrated with a PSP, wherein the authentication server subsequently itself locally issues a secondary or validation token (Tᵥ) for forwarding to the PSP.

### Detailed Sequence Diagrams

FIGS. 8 to 11 are detailed sequence diagrams.

Generally, the system comprises the following components:
Mobile wallet or eWallet—which typically comprises:
   A user interface (UI)—by which the caller/user 12 interacts with the wallet
   Wallet API (Application Programming Interface)—which typically comprises:
      Registration method module—which supports initial user registration.
      Payment method module—which supports payment method registration (largely independent of the payment process) and also payment initiation, whether by the user or merchant. In some embodiments these two functions are provided by separate modules.
      Crypto module—which handles cryptographic functions for the wallet API, specifically key exchange and secure connection to the federation/authentication server.
      Authentication module (“AWS module” or “3LW module”)—for performing the authentication algorithm which generates the authentication word strings. This requires access to the secure store for retrieving keys.
      Secure store—for storing keys/certificate on the user's smartphone. This needs to be secured against access by 3rd parties.
Authentication/federation server 16—which typically comprises:
   Wallet API—which supports the various functions used by smartphone users.
   Merchant API—which supports the various functions used by merchant applications.
   Crypto module (not shown)—having essentially the same functionality as the Wallet crypto module
   User enrolment database—which stores both static user enrolment information and dynamic values (keys indexes and IDs)
   Merchant database—which stores merchant registration/authentication information and any merchant payment related IDs eg. MIDs
   Key store database—which stores per-user keys (for authentication and timeslots) and merchant security information.
   Dictionary database—which stores:
      current and superseded dictionary values, eg. information relating to the dictionaries used within the word generation process
      notifications, eg. deferred notifications to offline users
      transaction log, eg. records of authenticated and failed transactions for later audits
Merchant server—which comprises a Payment App used by the merchant 14 to initiate payments
Payment processor 20, comprising a payment processor module which accesses via the appropriate API a payment provider interface, such as that for a PISP.

Alternative embodiments, have the various features distributed differently amongst the components.

The sequence diagrams make use of the following acronyms:

| Acronym | Description | Details |
|---|---|---|
| SID | Session ID for merchant payment | |
| MID | Merchant ID | |
| IMID | Internal Merchant ID | Value used by PSP and/or PISP to |
| | | identify merchant. May be a |
| | | credential set |
| TRID | Transaction ID issued by | |
| | Federation Server for a payment | |
| PMK | Payment method key | Identifies payment method |
| PmIdx | Index into payment methods list | Must be same in wallet and |
| | | federation server |
| Merchant ID Text | Friendly merchant name | eg. “Acme Rockets Ltd.” |
| MPIN | Merchant PIN value to present to | 1:1 map with MID, however can be |
| | customer in offline authorization | randomly generated per SID |
| | scenario | |
| OrderID | Merchant provided order identifier | Freeform |
| UUK | Unique User Key | Identifying User |
| DVID | Unique ID for dictionary version | Hash Value |
| KID | Unique ID for keytable version | Hash Value |
| Idx | Index into keytable | |
| Token | 1) authorized CC token for user, or | Could also be bank account details |
| | 2) auth key stored from other wallet/ | |
| | payment system | |
| TREF | Reference returned from PISP or PSP | |

### User Enrolment

FIG. 8 is a detailed sequence diagram for user enrolment, ie. for registering a user account with the authentication server.
S1. The user initiates the enrolment process via the eWallet user interface (UI) Enrolment information, sending user information and a telephone number to the registration method module of the user wallet API.
S2. The registration method initiates a new session with the crypto module, which establishes a secure communication channel (for example, by using transport layer security (TLS) or other cryptographic protocols) to the wallet API at the authentication/federation server. The server wallet API returns a success notification to the crypto module when a channel is successfully established. Otherwise, a failure notification may be transmitted, which ends the registration process.
S3. The server wallet API transfers the enrolment data to the user enrolment database, where it is stored. If this enrolment data is accepted (it may be rejected if it is incomplete, or if an error is identified), a success notification is returned to the server wallet API together with a unique user identifier (UUI). In some embodiments, enrolment data is rejected if an undesirable feature is detected, such a feature may be an inappropriate, or fake name, or a telephone number from a country without the required regulatory standards.
S4. The server wallet API then requests a unique user key (UUK) from the key store database. A UUK is generated transmitted to the Wallet API, with a copy being stored in the key store database.
S5. The server wallet API transmits the UUI, UUK, and a client certificate (generated by the server wallet API) to the wallet registration method module. The UUK and certificate are transferred by the registration method module to the secure store via the crypto module
S6. The wallet crypto module re-establishes the secure link with the server wallet API with the client certificate, and confirms successful enrolment with the registration method module.
S7. The registration method module then requests from the authentication server via the server wallet API a copy of the current authentication dictionary for the user (as identified by the UUI and UUK). The current dictionary (identified by a DVID and with an accompanying confirmatory hash) is retrieved from the dictionary database and transmitted to the wallet registration module.
S8. The registration method module then requests from the authentication server via the server wallet API key information relating to the seed keys used in the authentication word string generation algorithm. Key information (specific to the user) comprising a key ID and key table index, is retrieved from the user enrolment database and transmitted to the wallet registration module.
S9. Transfer of the key table itself from the key store database on the authentication server to the secure store on the ewallet is done via Diffie-Helman key exchange between the crypto module and the server wallet API.
S10. Successful transfer and local storage of the key table completes the enrolment process. The user is notified accordingly.

During User Enrolment the service may also support the ability of instead of using pre-generated key tables to use a single pre-shared high entropy seed that will be used to generate unique keys for each transaction. Transaction keys will preferably be:
at least 128 bit long
generated on usage, through a standard key derivation function, and using transaction-specific auxiliary inputs including, at least, the key index, the TPIN and the MPIN
generated using a slow key derivation function (such as PBKDF2) with either a truncated HMAC (for example HMAC-SHA256) or of a keyed extendable output function to generate selection strings

Pre-shared seed generated would be held on a HSM when on the Federation Server.

### Registration of Payment Means/Methods

FIG. 9 are detailed sequence diagrams for registering payment means/methods with the authentication server. The terms payment means and payment method may be used interchangeably.

The user is assumed to have already enrolled with the authentication server and to have an account with a payment server.
S1. The user selects a payment means to register via the ewallet user interface (UI).
S2. The payment method module initiates a new session with the crypto module, which establishes a secure communication channel with the client certificate to the wallet API at the authentication/federation server.
S3. A Diffie-Helman key exchange is performed between the crypto module and the server wallet API to allow subsequent transfer of sensitive payment data from the secure store on the ewallet to the authentication server to be encrypted.
S4. Details of the payment means/method are tokenised and registered with the payment processor, which issues a suitable token in return which is stored with a payment method key (PMK) in the user enrolment database.
S5. The payment method key is transmitted by the server wallet API to the payment method module of the eWallet to complete the process.

FIG. 9a is a sequence diagram for registering a credit card with the authentication server, wherein the payment information comprises a primary account number, a card verification value (CVV) and other card information, such as an expiry date.

FIG. 9b is a sequence diagram for registering a bank account with the authentication server, wherein the payment information comprises a bank account number, a sort code, and a name. This information is transferred to a PISP, where it may be stored together with other payment information.

### Online Payments

FIG. 10 is a detailed sequence diagram for online payment.

The user is assumed to have already enrolled with the authentication server and to have registered a payments method.

The merchant will preferably have previously registered with the server, in a similar way to a user, such that merchant details are stored by the authentication server in the merchant database.

User selection of the payment method
S1. The user confirms order details with the merchant.
S2. The user opens the ewallet and selects the user interface (UI) the payment method to be used.
S3. The ewallet payment method module initiates a new session with the crypto module, which establishes a secure communication channel with the client certificate to the wallet API at the authentication/federation server.
S4. The payment method module sends a payment method key (PMK) indicating the selected payment method to the server wallet API. The PMK is checked in the user enrolment database against payment methods registered for the user and the payment method is set for the transaction accordingly.

Merchant payment request
S5. The merchant uses a merchant payment application (‘app’) to submit a payment request to the merchant API at the authentication server via a secure communication channel.
S6. The merchant API first confirms the merchant identity (MID) against the merchant database before issuing the merchant server app with a session ID for the transaction.
S7. Details of the payment request (including transaction-specific transaction ID TRID and merchant pin MPIN) are pushed from the merchant API, via the wallet API to the payment method module of the ewallet.
S8. Details of the payment request are presented via the ewallet UI to the user for approval.

User acceptance of the payment request
S9. Acceptance of the payment request by the user is relayed from the payment method module of the ewallet via the server wallet and merchant APIs to the merchant app. The acceptance is provisional subject to authentication of and authorisation by the user by a word authentication string (AWS/3LW).

Authentication word string—User
S10. The payment method module prompts the ewallet 3LW module to generate an authentication word string on the basis of the relevant transaction information, for example the merchant identifier MPIN, transaction information (an amount, a timestamp), user account information (a dictionary version ID, a payment method key, and a keytable index).
S11. The wallet 3LW module confirms sensitive information against that stored in the ewallet secure store and generates an authentication word string for the transaction.
S12. The authentication word string is returned to the payment method module for display to the user via the ewallet user interface.
S13. The user then speaks the authentication word string aloud such that it is transmitted via a voice channel to the merchant.

An alternative to the 3LW generation is outlined and this approach splits the token generation into three different phases:
Transaction key generation, where the pre-shared seed is used, in combination with some transaction-specific information, to generate an authentication key unique to a particular transaction;
Authenticator string generation, where the key is used to generate a machine-readable authenticator string for application data; and
Token selection, where the authenticator string is turned into a human-usable token namely the 3LW.

Transaction Key Generation

Given the pre-shared seed KT, a transaction key Kₜ with key index Idx, time code tc, merchant PIN MPIN, and transaction PIN TPIN (an additional, user chosen, 4 to 8 digit code) can be generated as follows:

Kₜ=KDF(KT, Idx∥tc∥∥MPIN∥TPIN)

In the above:
KDF is a secure key derivation function
Idx is a monotonically increasing key index,
tc is the time code for the time at which the transaction occurs, and TPIN is an additional user-chosen transaction PIN.
∥ denotes reversible concatenation (for example, simple concatenation success if all fields have a fixed length).

A key generation technique equivalent to the optionally proposed use of key tables can be recovered by not including tc, MPIN or TPIN in the computation. However, including them serves to mitigate online dictionary attacks by parties who hold the pre-shared seed (the User and Federation Server). Barring collusion, each of these parties controls at most one of the key derivation's auxiliary inputs (tc, MPIN and TPIN), which can therefore be used to make the attacker's task more costly. The additional user-selected auxiliary input TPIN provides this protection to the user.

Note that the Idx is used to prevent an adversary from starting the attack offline (by including transaction-specific information in the key derivation), slowing down the process through which transaction keys are generated (using PBKDF2 or a similarly designed KDF or password-hashing function), and forcing incrementation of the key index Idx on failure.

Authentication word string-Merchant
S14. The merchant enters the authentication word string received from the user into the merchant payment app, from where it is transmitted to the server merchant API together with the session ID and transaction ID.
S15. These details allow the merchant API to determine further details of the transaction and the user (for example, DVID, KID) and request the server 3LW module to generate a corresponding expected authentication word string (EWS), sensitive information such as the user key having been retrieved by the 3LW module from the key store database. The server 3LW module generates the expected authentication word string using the same parameters and algorithm as were used by the wallet 3LW module.
S16. If the expected authentication word string matches the authentication word string received from the user by the merchant, the transaction is considered authorised. An authorisation notification is sent from the server 3LW module via the server merchant API to the merchant payment app.
Otherwise, if the expected authentication word string does not match the received authentication word string, a rejection notification is issued.
S17. For an authorised payment, server merchant API transmits a payment authorisation (comprising a merchant ID, transactional information and an authorisation token) to the payment processor to effect payment

User and merchant notifications
S18. Once payment is successful, notifications are returned from the payment processor to the server merchant API, to the merchant payment app and via the server wallet API to the ewallet payment method module—and thence to the user interface where it is displayed to the user.

### Offline Payments

FIG. 11 is a detailed sequence diagram for offline payment.

The process is initially similar to that for an online payment, where a user confirms order details and selects a payment card, except that:
i) the crypto module is unable to establish a secure communication channel to the wallet API at the authentication/federation server; and
ii) the merchant API is unable to push details of the payment request via the wallet API to the payment method module of the ewallet.

Instead, the merchant relays via the voice channel a one-time merchant identifier MPIN, valid only for the specific transaction, to the user for the user to input via the ewallet UI and to be used in the generation of the authentication word string.

The MPIN is likewise used by the server 3LW module to generate the corresponding expected authentication word string (EWS).

Similarly, without connectivity notifications cannot be immediately sent via the server wallet API to the ewallet payment method module. Instead, the notification remains stored in the server notifications module until the next time the user device connects to the authentication server.

### Reverse Authentication

FIG. 12 is a sequence diagram for merchant authentication.

This allows for a merchant to confirm to a user that they are genuine—and more generally for a user to guard against fraudulent parties which is a common issue for outbound banking or insurance telephone calls.

Generally, the process involves the merchant presenting to the user a one-time passphrase or authentication word string based on merchant and user identifiers which can be separately confirmed by the user.

The process proceeds as follows:
S1. Merchant 14 is in telephone communication with a user.
S2. The merchant registers the call with the authentication/federation server 16, forwarding call information such as the MerchantID and user telephone number.
S3. A subsequent query from the user (typically via an authentication app, potentially part of an ewallet) to the authentication server, forwarding a user ID, results in the sever generating a one-time authentication word string in dependence on the user ID and call information.
S4. The authentication server transmits the authentication word string to the merchant and to the user, where it is displayed on the user device.
S5. The merchant speaks the authentication word string to the user which the user compares to the (expected) authentication as displayed. A match indicates the merchant is authentic.

In some embodiments, the authentication word string is not transmitted to the user device but rather only call and merchant details are transmitted such that the user device itself determines the expected authentication word string.

### Creation of an Authentication Dictionary

FIG. 13 shows a process for creating an authentication dictionary, as used for selecting the constituent or component words of an authentication word string.

An authentication word string AWS for voice transmission preferably comprises distinct words which are easy to pronounce and difficult to confuse with other similar sounding or similarly spelt words.

Creation of an authentication dictionary generally proceeds via the following sequence of steps:
S1. An initial list of words is compiled 802. This may involve selecting words from one or more existing sources 850, such as dictionaries 852, books 854, and websites 856. The words are not necessarily all in the same language. The compilation may also involve the creation of new words, for inclusion alongside existing words. Compilation may involve both the addition and the removal of words to an existing set of words.
S2. In 804, words with greater than a predetermined number N of letters are removed from the list, where N is typically 6, potentially 7, 8, 9 or more. This may result in a list with words which are more memorable or more pronounceable.
S3. In 806, words with fewer than a predetermined number M of letters are removed from the list, where M is preferably 3, potentially 4, 5, 6 or more. This may result in a more memorable or understandable list.
S4. In 808, words which are difficult to pronounce are removed from the list. This is particularly desirable if the words are to be transmitted via voice.
S5. In 810, sets of similar sounding words are removed from the list. One or more words from the set may be removed, or a single word may be kept. This may result in a list with words which are easier to communicate via voice.
S6. In 812, words which are difficult to spell are removed from the list. This reduces the chance of an agent or other party which may need to input the spoken words into a computer system for transmission to the authentication server making a typographic error.
S7. In 814, words which do not follow a theme are removed from the list, so that a list is created where the words are related to a common theme. This may be used to generate more memorable words or may be used to relate the words to a current event or to the transaction, for example a transaction related to buying sporting goods may follow a sports theme. This theme may be selected based upon a feature of the transaction, such as the location, the time, or the service being requested. Alternatively a theme may be selected by the authentication server 14, or randomly chosen.
S8. In 816, the list is saved as an authentication dictionary 818. Dictionaries may be generated on a user device, such as a smartphone, and saved locally on the device, where it may be possible to transfer dictionaries between devices. Dictionaries may be stored remotely, for example on the authentication server, such that a user is able to select and optionally download an authentication dictionary.

The above process results in an authentication dictionary which is especially suitable for vocal transmission of words, as selection is partly based upon pronunciation 808 and removing similar sounding words 810.

Any other undesirable sets of words may also be removed, for example offensive words, copyrighted words, or words which are difficult to read, write (for example words containing letters which are difficult to reach on a keyboard), hear, or explain. The authentication dictionary may comprise words according to a subject or theme.

The user may be able to add or remove words from a list, this would allow a user to form a personalised dictionary of words that they find easy to remember or pronounce. Such a personalised dictionary may also be used to increase the security of the method, as any malicious third party may need to acquire this dictionary to attempt to replicate authentication words.

Words may also be added into the list before or after any step. Words that have been removed may be reintroduced, for example, words which do not follow a theme 814 may be included if they are nevertheless easy to pronounce.

Any combination of the word removal/addition steps may be performed in any order, or omitted.

Copies of the authentication dictionary are made accessible to both the user and the authentication server, potentially stored in different formats in the same or at different locations, preferably downloaded in whole or in part to local storage

In some embodiments, a master authentication dictionary is created from which each user may create a personal authentication dictionary.

In some embodiments, authentication dictionaries may be regularly updated, for example every day, or every week, or upon an event, for example a dictionary may be updated after being used a maximum number of times.

Whereas an (English) dictionary may contain in excess of 100,000 words, an authentication dictionary AD created by the above process may contain only 20,000 or 22,000 words, potentially 4,000 to 5,000 words, say approximately 4,100 words. Generally, an authentication dictionary may be of any size. For example, a small dictionary may be desirable as it will take up only a small amount of storage space on a user device.

The size of the authentication dictionary may relate to the security of the authentication/authorisation process, ie. for an authentication word string comprising a given a number of words, use of a smaller dictionaries may result in lower password entropy than a larger dictionary.

The security of the authentication/authorisation process may also depend upon other features of the dictionary, such as the commonality of words (where a dictionary containing seldom used words may be considered to be more secure), or the number of different languages used.

The authentication dictionary may in some embodiments be selected by the merchant, for example to ensure a specific level or degree of security in view of the type or size of the transaction.

Authentication dictionaries of different sizes may be generated to provide different single-word entropies. The generation of dictionaries generally involves selection of suitable words and the factors considered for word selection may include suitability for speech recognition/generation technologies, ie. the authentication dictionary may be optimised for one or both of speech recognition/generation.

FIG. 14 is a schematic of an authentication dictionary, based on an initial list of words, with words removed from the list according to one or more of:
having greater than N letters 864,
having fewer than M letters 866
being difficult to pronounce 868 or spell 872
having similar sounding words 870
not following a theme 874

The remaining words are saved as the authentication dictionary 818.

The sets of removed words may overlap, as words which are difficult to spell may also be difficult to pronounce. Any set of removed words may, or may not, overlap with any other set, save for the sets of words with greater than N letters 864 and fewer than M letters 866, which sets are chosen to be distinct else the authentication dictionary would be an empty set.

In some embodiments, there may be a minimum number of words required in a dictionary. This may improve security as a larger dictionary has a higher number of potential authentication word strings.

In some embodiments a dictionary is generated immediately before the authentication word string is generated. A method of generating such a dictionary may use ‘tags’, wherein each word in an existing dictionary is ‘tagged’ with related information, such as the number of letters in a word, the spelling or pronunciation difficulty or how common the word is in everyday language. Words with certain tags, for example words of a certain length, or spelling difficulty, may be selected from an existing dictionary to create a new dictionary. Generating dictionaries in this way enables dictionaries to be formed for a variety of scenarios. The user may select tags to be used, or the tags used may depend upon the transaction or transmission channel. Using tags, a large dictionary of words and/or sentences may be downloaded, and a smaller dictionary suitable for a particular transaction created immediately before the word string is generated.

In some embodiments, the dictionary may contain sentences instead of words (or a combination of sentences and words). This may be used to create a more memorable word string, as a sentence may be more memorable than a word string comprised of random words.

When using offline authentication the authentication server 16 cannot transmit information to the user 12, this may result in additional information, such as a dictionary of possible authentication words, being required to be stored upon a user device. As this information takes up storage space on the user device, there may be stored only a subset of information which can be used in the generation of the authentication word string, for example a limited dictionary from which authentication word strings are chosen may be stored. Offline authentication may require a greater number of words to be used to achieve the same level of security. Higher value transactions may also require the generation of additional words.

Any features described as related to a dictionary may also be relevant for word generation, and vice versa, ie. the word list from which an authentication string is chosen may be limited by generating a dictionary with desired features, or may be limited by only selecting words with these features at the time of generation.

### Generation of an Authentication Word String

Generally, an authentication word string is determined according to the algorithm of the form:

AWS=Eₖ(P)

where
AWS=authentication word string
P=plaintext (payment details, such as details of user payment card or bank account plus the amount or Value of transaction)
E=encryption method (used to determine word replacements for the plaintext from the dictionary authentication)
k=key (seed for random number generator RNG component of algorithm)

Other factors may be included to improve security further.

Each word in the authentication dictionary is assigned a number and the outcome of the algorithm indicates the constituent words of the authentication word string.

For online authentication, the key k may be transmitted from the user and authentication server alongside the authentication word string. Offline authentication is discussed separately below.

The number of words to be generated may depend upon the transaction, for example if the transaction concerns a small payment 1 or 2 words may be considered sufficiently secure, whereas if a large payment is being made it may be desirable to use a greater number of words for increased security.

For example, for an authentication words derived from a dictionary of 22,000 words, each word of the authentication word string has an entropy H=Log 22,000/Log 2=14.24, hence an authentication word string (AWS) comprising three such words (alternatively referred to as “3LW”) has an entropy of 43.28, or reasonable level of security.

The authentication word string may be made longer, say to five words (alternatively referred to as “5LW”) or more, to provide a greater entropy hence higher level of security.

In some embodiments, the words generated may have some connection, for example the words may form a sentence, or share a common theme. This connection may occur due to the dictionary which the words are selected from, or may be occur due to the method of word generation.

One or more words may also be preselected from the server: this may be used so that, for example, each transaction occurring in a store uses the name of that store as one of the words.

In some embodiments, the number of words may be selected 1008 by a regulatory body, or this body may specify a minimum number of words, where the user or agent may then select a number equal to or greater than this minimum. The number of words used may also be dependent upon the dictionary used, where a smaller dictionary may require more words.

The dictionary selected 1006 to generate words may be selected in in dependence on a feature of the transaction, so that, for example, a sufficiently secure dictionary, such as a dictionary comprising at least a minimum number of words, may be required for large payments.

The dictionary used may depend on a selection made by the user, merchant, or server.

In some embodiments, the dictionary may be selected in dependence on the quality of the transmission channel, for example, an imperfect telephone connection may result in the selection 1006 of a dictionary comprising easily distinguishable words. Such a dictionary may be smaller than that used with a better quality connection, so that more words may be required to obtain a sufficiently secure password.

For offline authentication, the user and the authentication server need to agree on the correct authentication word string despite not being in direct communication.

This is achieved by making the key time-dependent—which may also be used for online authentication.

FIG. 15 shows a method of time-based word generation.

To allow for imperfect synchronisation, the day is divided into time intervals of length n.

For example, some embodiments divide the day first into 12 hours 1102, and then further divided into 5 minute intervals within each hour 1104, so that there are 288 intervals each day. Word generation is therefore dependent upon the time to within a 5 minute interval. In some embodiments, shorter, say two-minute, intervals may be used. Alternatively, longer intervals may be used.

The time-to-live (TTL) of the authentication word string AWS, and the number of past and future expected word strings EWS against which it is compared may be selected by the user, merchant, or authenticating server—or be determined by a property of the transaction.

Generally, the interval is configurable, typically according to the quality of the communications channels and/or the required level of security. For example, authentication word strings used for high value transactions may have a shorter TTL.

In practice, the authentication server allows for a degree of imperfect synchronicity (as well as user delay) by having authentication word strings with a maximum time to live (TTL) of between n and 2n minutes, ie. for any received authentication word string the authentication server computes the present (t) and at least one of the immediate past (t−1) and immediate future (t+1) expected word strings for use in authenticating the user.

For example, if a user generates an AWS for 01:48, but does not submit it until 01:52, this will not be an issue as the authentication server will calculate the expected EWS and compare received AWS for both 01:45 and 01:50.

A further refinement has each 5 minute time slot assigned a different pre-shared key, such as pseudo-random numbers from a random number generator RND. In practice, arrays or grids of keys are shared at a time, securely using Diffie-Hellman key exchange. Essentially this introduces perfect forward secrecy (also known as ‘one time pad’ encryption) into the generation of the authentication word strings.

Offline usage requires the keys to be downloaded before use, the keys being updated when the user has online functionality. For example the keys for the next 30 days (the next 8,640 keys) are stored on a user device, and are updated whenever the user reconnects online.

Transmission of the keys may also take place using a less secure method over a secure channel, for example keys may be delivered to a user address on a storage media, such as a hard drive. A large number of keys may be contained on such a media, where a subsection of these may be transferred to a user device each 30 days.

### Processing the Authentication Word String

FIG. 16 shows a method of processing the authentication word string, in particular when it involves an agent in voice communication with the user.

When an agent 14 hears 1202 an authentication word string spoken by a user, the agent will attempt to interpret 1204 the sounds as dictionary words even if the sound is unclear. For example if the agent hears the user say “plebble”, this agent is likely to interpret this as “pebble”. This may provide an advantage of using (whole) words in the authentication string rather than individual characters, wherein the agent may be unable to differentiate between a single spoken “m” or “n”, and not have any word context in which to conclude either way.

The effectiveness of the word string authentication may be further improved by using a dictionary selected to avoid similar words. For example, if “treble” is the only word in the dictionary which ends in “ble”, the authentication server 16 will correct 1208 an authentication word string forwarded by an agent 14 with the word “pebble” by replacing it with the correct word “treble”.

The agent 14 may be provided with a list of possible words, or a predictive text feature, which may suggest words, where these words may be in the dictionary (here suggesting ‘treble’ rather than ‘pebble’).

The authentication server 16 may correct for typographic errors.

The authentication server 16 then compares 1212 the received authentication word string AWS to the expected word string EWS. If the words match the server authenticates 1214 the request.

If the AWS and EWS do not match, the authentication server 16 may reinterpret 1208 the word string, so that the server may compare 1212 both the initial version of words input 1206 by the agent 14 and one or more word strings based on this input. The error checker may suggest corrections to either the agent or the user.

A range of words may be acceptable, so that if the words entered are within a set range of the words expected the user is authenticated. This range may be a written range or a vocal range, i.e. there may be an acceptable range or number of typographic errors, or there may be an acceptable range of similar sounding words.

In some embodiments, the agent 14 may be able to input and transmit a word using an indicator, instead of the letters comprising the word, for example a number may be input using digits, where a user may vocally transmit ‘nine’, an agent may be able to enter ‘9’;

similarly a transmission of ‘ampersand’ may be indicated by an agent entering ‘&’.

### Identification & Verification

FIG. 17 shows use of the authentication process in Identification & Verification.

An AWS word time-based token is used to identify a user (as opposed to validating a user device) by requiring biometric verification to release an AWS authentication/access token.

As the AWS token is delivered supporting Strong Customer Authentication (SCA), that is dual-factor authentication over two separate delivery channels, it may be used as an effective and highly secure corridor for the transmission and receipt of authorisation requests.

This process can work in either “direction”:
Validating consumers-Authorisation
Validating merchants-Reverse Authorisation

In the example shown:
S1. Merchant requests user authentication/authorisation from the federation server, based on the user telephone number and merchant ID.
S2. The request is forwarded from the federation server to the user device.
S3. The user accesses the authentication app via a biometric and generates an authentication word string (3LW).
S4. The authentication word string is relayed verbally by the user to the merchant.
S5. The merchant confirms the received authentication word string matches the expected authentication word string as generated by the federation server.

### Alternative Embodiments

In some embodiments, the authentication server will only accept or authenticate an authentication word string received from a predetermined location or party.

Words for the authentication word string may be selected from a combination of dictionaries.

For example, a number of words may be selected from a master authentication dictionary and a number from a personal user dictionary.

Using a large master dictionary may increase security by ensuring a high password entropy, whereas using a smaller personal user dictionary may increase security by ensuring that a third party requiring access to the personal dictionary in order to impersonate the user.

In embodiments which do not involve an agent as an intermediary, functions described as being performed by the agent may instead be performed by the user and/or the service provider.

Any of the user, agent, or service provider may transmit the authentication word string (and any other required information) to the authentication server. Alternatively, the authentication word string may be transmitted from the user or agent to the service provider, before being transmitted to the authentication server. Any of the user, the agent, the service provider, or a combination thereof may transmit the authentication word string to the authentication server either directly or via any other party or combination of parties.

In some embodiments the authentication word string is transmitted visually rather than via voice. This may be useful noisy environments where the user and the merchant cannot hear each other.

In some embodiments the authentication may use gestures. There are situations in which speaking an authentication phrase is either not possible or not desirable, for example where a camera, or another visual detector, is being used to monitor a secure area. It may also be impossible, or undesirable, in such a situation, to use a written means to authenticate a user. Authorisation via gestures may comprise a ‘gesture string’ comprising one or more gestures selected from a dictionary of gestures, such as a “wink”, “smile”, or “jump”. A camera, or an agent observing the camera feed, may observe these actions in order to authenticate the user.

In some embodiments, transmission of the authentication word string or other information may be sent via various other communication channels, for example via simple messaging service (SMS).

Generally, the type or size of transaction which may be allowed to be authenticated by this method may depend on the inherent security of the channel(s) used. For example, SMS may not be considered sufficiently secure, and therefore unsuitable, for high value transactions.

In some embodiments, access tokens resulting from a successful authentication may be provided by the authentication server to any of the other participating parties.

Details of successful and/or unsuccessful authentications may be recorded. This may allow, for example, the user to report unsolicited payment requests from merchants or other abuses of the service.

Embodiments may also be used with a voice activated home hub (such as Amazon Alexa or Google Home Assistant), which may be used similarly to a mobile wallet software development kit (SDK), to call the federation services for the Payment and Reverse Authentication use cases.

In some embodiments, the TLS channel is mutually authenticated (for example, using a client certificate) between the user and the federation server, therefore no adversary can impersonate the client to the Federation Server or vice-versa. It is worth noting that the client (as the User's Device or a piece of software on the Device) could be compromised to present to the User information that is not accurate. The Federation Server and service operator may wish to inspect client applications and Devices that wish to interoperate with it to ensure their trustworthiness with the capability to disconnect or prevent further account use where devices are suspected of compromise.

While the detailed embodiments set out herein are primarily concerned with authenticating a user in order to authorise a payment, the methods disclosed may be used to authenticate a user for other reason. For example, a user may wish to access a secure area, physical or virtual, where the methods disclosed may be used in lieu of or in combination with a password. The user may wish to access, or release to another entity, sensitive personal information, such as a driving license or a bill or register for a service or website.

It will be understood that the invention has been described above purely by way of example, and modifications of detail can be made within the scope of the invention.

Reference numerals appearing in any claims are by way of illustration only and shall have no limiting effect on the scope of the claims.

1. A method (preferably, performed by an authentication server) of authenticating a request made by a first party of a second party, comprising:
receiving from the first party a request and a first symbol string obtained by the first party from the second party, the first symbol string being determined from the request; generating a second symbol string in dependence on the request;
authenticating the request of the first party in dependence on the first and second symbol strings.

2.-27. (canceled)
